(19) United States
(12) Patent Application Publication
(10) Pub. No.: US 2009/0295509 A1
(43) Pub. Date: Dec. 3, 2009

(54) APPARATUS AND METHOD FOR REACTION OF MATERIALS USING ELECTROMAGNETIC RESONATORS

(75) Inventors: Neel S. Master, Santa Monica, CA (US); Reza Arghavani, Scotts Valley, CA (US); Frederick M. Espiau, Topanga, CA (US); Mehran Matloubian, Encino, CA (US)

Correspondence Address: JOSHUA D. ISENBERG;JDI PATENT, 809 CORPORATE WAY, FREMONT, CA, 94539, US

(73) Assignee: Universal Phase, Inc., Santa Monica, CA (US)

(21) Appl. No.: 12/423,762

(22) Filed: Apr. 14, 2009

Related U.S. Application Data
(60) Provisional application No. 61/128,984, filed on May 28, 2008.

(51) Int. Cl. H01P 7/10

(52) U.S. Cl. 333/219.1

(57) ABSTRACT

An electromagnetic resonator may be used for efficient heating and/or reaction of materials. More particularly, resonator-based systems may be used for efficient pyrolysis, gasification, incineration (or other similar processes) of feedstock including but not limited to biomass, petroleum, industrial chemicals and waste materials using RF resonators and adaptively tunable RF resonators. A processing architecture based on the use of resonators is presented.

### CLAIM OF PRIORITY

This Application Claims the priority benefit of co-pending U.S. Provisional Patent Application No. 61/128,984, filed May 28, 2009 to Neel Master, Frederick Espiau, and Mehran Matloubian entitled “EFFICIENT HEATING, PYROLYSIS, GASIFICATION AND INCINERATION OF MATERIALS USING RF RESONATORS”, the entire contents of which are incorporated herein by reference.

### FIELD OF THE INVENTION

Embodiments of the present invention are directed to the use of electromagnetic radiation, to drive reactions in a feedstock and more particularly to apparatus and methods that use an electromagnetic resonator to concentrate electromagnetic energy to drive a reaction in a feedstock.

### BACKGROUND OF INVENTION

Microwave processing has been used in a broad range of applications due to the potential benefits of the approach which include uniform heating, fast reaction times and energy efficiency. Microwave processes have advantages in that they can potentially use renewable energy in the form of electricity as opposed to conventional fossil fuel based heating approaches. Microwave processes are in many cases a cleaner, faster and more uniform process than traditional approaches to heating. Microwave processes can be used in a wide range of temperatures ranging from 20° C. to over 6000° C. A broad range of input and feedstock materials can be used including solids, liquids and gases varying significantly in dielectric constants and microwave reflectivity and transparency.

Microwave apparatus has also been used in the processes of pyrolysis and gasification of biomass, coal, municipal solid waste, sewage waste and other feedstock for the creation of gas, liquid (pyrolysis oil or bio-oil) and char. See, for example, U.S. Pat. No. 4,759,300. An advantage of using microwave apparatus is the ability to develop a system in a much smaller footprint than traditional approaches. See, for example, U.S. Pat. No. 5,366,595. These thermochemical conversion processes are used in but not limited to waste to energy, biorefinery and other renewable energy applications. See, U.S. Pat. Nos. 4,937,411 and 5,387,321.

Microwave equipment has been used in chemistry applications including transesterification, which have resulted in enhanced reaction rates over conventional heating methods. See, U.S. Patent Application Publication numbers 20050274065 and 20060162245.

Microwave processing has been applied to oil including breaking oil and water emulsions (U.S. Pat. No. 6,077,400), upgrading of low value hydrocarbons (U.S. Pat. No. 5,328,577), recovery of oil from tar sands and oil shale deposits (U.S. Patent Application Publication Number 20070181465). It has been applied to the refinement and upgrading of industrial chemicals (U.S. Pat. No. 6,106,675). Microwaves processes have also been used to generate plasmas (U.S. Pat. Nos. 6,362,449, 6,717,368, 7,227,097, and U.S. Patent Application Publication Number 20060018823) for a number of applications including conversion of carbonaceous matters, heating, melting and sintering. Plasmas have also been used in the disassociation of chemicals with strong bonds including CO₂. See, for example, Indarto et al, Journal of Natural Gas Chemistry 14(2005), pages 13-21 “Kinetic Modeling of Plasma Methane Conversion Using Gliding Arc.” The process has also been used to decompose hazardous substances (U.S. Pat. No. 6,787,742) typically at high temperatures above 1500° C.

Microwaves have been used in industrial heating processes (U.S. Pat. Nos. 5,389,335 and 6,590,191) for sterilization, pasteurization, and other treatment of heat-sensitive materials typically in ranges from 50° C. to 2000° C. The prior art has also involved improving traditional microwave ovens for improving the efficiency and results of traditional food preparation (U.S. Pat. No. 6,864,468). Microwaves have also been used in the heating of water (U.S. Pat. No. 6,472,648).

Microwave processes have also been employed to generate hydrogen. See, for example, U.S. Pat. No. 6,592,723.

Unfortunately, the prior art in this field has several limitations. For example, previous microwave equipment process designs have not optimized the efficiency of the microwave process. A fundamental factor in the efficiency of such a system is to effectively guide electromagnetic energy as efficiently as possible and couple it to the material being heated with as little loss as possible. Prior art attempt at improved efficiency has used waveguides or a dielectric slab for improved focusing of the energy. (U.S. Pat. Nos. 6,061,926 and 6,265,702). However these approaches are still susceptible to significant losses and cannot be adjusted easily or dynamically to maximize RF energy coupling to material being heated.

Another limitation is that present microwave approaches are fairly static and do not adapt dynamically and/or automatically to the input material. The results of the microwave process are heavily dependent on the characteristics of both the microwave apparatus as well as the dielectric and microwave reflectivity characteristics of the feedstock or input material. This typically has required equipment to be tuned specifically for a feedstock, and overall effectiveness is ultimately limited by the characteristics of available microwave sources such as magnetrons, amplifiers and other components. In some cases a specific apparatus is designed, assembled and based on variations of the characteristics of the same type of feedstock. See, for example, U.S. Pat. No. 5,084,054. The prior art has used addition of materials to change the dielectric characteristics of the materials to improve matching with the equipment. One prior art example describes use of an automatic E-H tuner to match the impedance of the transmission line to the load of the reactor for improved power absorption. See, e.g., Robinson et al “Pyrolysis of Biodegradable Wastes Using Microwaves,” J. P. Robinson PhD, S. W. Kingman PhD, C. E. Snape PhD and H. Shang PhD, Waste and Resource Management 160 Issue WR3. However these approaches lack a platform for dynamically adapting microwave characteristics to the initial feedstock as well as changes during the reaction.

Currently these approaches have challenges in providing scalable processes that can scale to large throughput and capacity while maintaining efficiency and control. This includes prior art in batch, semi-continuous and continuous flow reactions.

### SUMMARY

According to an embodiment of the invention, a dynamically tunable apparatus may use an electromagnetic resonator for processing of a feedstock material. A device for reacting a feedstock may comprise an electromagnetic resonator and a feedstock tube. The electromagnetic resonator is configured to concentrate electromagnetic energy into a reaction zone within the resonator with sufficient energy density to drive a reaction in the feedstock as the feedstock flows through the reaction zone. The feedstock tube is disposed in the resonator and the reaction zone. The feedstock tube is configured to permit the flow of feedstock through the reaction zone.

By way of example, and not by way of limitation, the processing may include thermochemical conversion, pyrolysis, gasification, electrolysis, pasteurization, disassociation of chemical bonds as well as traditional heating and cooking. The input material can include any type of fuel feedstock (coal, petcoke, biomass, municipal solid waste, petroleum) as well as water, liquids, industrial chemical, solids, gases (CO₂) and hazardous wastes.

Embodiments of the present invention provide distinct advantages over microwave processes in the background art. The use of resonators enables a comprehensive microwave processing architecture enables a highly configurable, dynamically controlled microwave process that results in a significant number of fundamental advantages over prior art.

Firstly using a resonator or cavity structure results in microwave energy being focused with significantly greater efficiently into a specific region. This enables much faster reaction rates, high heating uniformity, a greater range of temperature range and control over residence time.

Furthermore, resonators can be designed to match the frequency of the input material for the application. In addition using resonators in an oscillator configuration with feedback allows the frequency of RF source to dynamically change as the input material dielectric properties change with temperature. This results in a much higher energy coupling in addition to highly efficient frequency matching of microwave source and input material than traditional microwave approaches.

Resonators may be composed of dielectrics, partially filled dielectrics or air. A combination of different resonator types can be used simultaneously or in coordination for desired heating and processing effects. Another fundamental advantage of the approach described herein is that a resonator can be tuned dynamically to match the materials being processed. Resonators can be used in serial to increase the reaction area, or to provide non-uniform heating or heating which occurs in stages. Resonators can be pulsed or turned on/off to vary the time of the heating process in-situ. Resonators may take on any suitable shape. By way of example and not by way of limitation, resonators can be circular or rectangular in shape.

Resonators enable the use of solid-state power sources in addition to traditional means. This allows a platform for lower-cost, more efficient power sources which can be dynamically controlled with high precision.

The resonator-based reactor architecture described herein may be extended to both plasma and non-plasma processing. Configuring a plasma based process extends the temperature range significantly while maintaining significant energy efficiency. The difference in configuration between plasma and non-plasma processing is minimal and enables a single system which can perform both for incremental cost and increase in form factor. The plasma acts like a catalyst and reduces the activation energy that is required to start the chemical dissociation of the carbonaceous material.

The use of resonators for efficient coupling of microwave energy significantly extends the traditional advantages of microwave processing in terms of reaction rate, heating uniformity, temperature range and control over residence time.

The architecture of the system extends itself to dynamic and adaptive control for microwave processing. Dynamic including real-time feedback can be incorporated with the resonators by monitoring temperature, dielectric properties and other sensing modalities. This information can be used to continually adapt the power input, frequency and dielectric properties of a single or combination of resonators to desired effect.

Dynamic control of a single resonator can be implemented due to the virtue of the resonator architecture. In one embodiment this can be implemented as a circuit that establishes a controlled feedback loop that processes sensor information about the dielectric and mass properties of the feedstock material, temperature, pressures and other sensor modalities, and uses a processor to control the input power, frequency and dielectric properties of the resonator as shown in FIG. 10A. The processor can be programmed to optimize a number of factors to desired effect. A number of key factors that can be optimized include (but are not limited to) the following:

Reaction rate—The rate of heating can be controlled dynamically. Given the very fast reaction rates possible by using a resonator, the control of the rate becomes important for optimizing the process.

Heating uniformity—A resonator can be controlled dynamically to provide very precise heating uniformity over a very specific region in the vessel. As the reaction changes the composition of the input material, the resonator can be controlled to compensate for changes to the composition to maintain optimal heating uniformity. This may be critical for certain specific chemical conversion processes, as well as for efficient use of input power.

Temperature range—A resonator may be dynamically controlled to provide heating at a specific temperature or range of temperatures over time based on the application and feedback from sensors. For example a slurry of coal and steam may have a non-uniformity of particles which can be sensed in the reactor based on dielectric and other properties. Based on this the temperature range (as well as other factors) can be adjusted automatically for optimal results.

Residence time—A resonator can be controlled to provide heating for very short bursts or long reaction times. This is important as, due to the efficiency and fast heating rates of the resonator approach, a process may be configured to develop very short or long residence times based on the applications. Furthermore, the residence times may be optimized based on real-time feedback based on the actual reaction, as opposed to manual input through trial and error. This becomes particularly useful for material that has non-uniformities such as biomass, waste and other materials.

Dynamic control over a series of resonators as depicted, e.g., in FIG. 8 may also be implemented by virtue of the resonator architecture. In one embodiment, a circuit can be formed across a series of individually dynamically controlled resonators. Each individually controlled resonator can take input from a master circuit to coordinate the heating process over a larger region and longer process time. With the use of an auger system to control the flow of the input material, the processing can be staged over discrete or continuous time.

Dynamic control over resonators in parallel, e.g., as depicted in FIG. 9, may also be implemented by virtue of the resonator architecture. Each individually controlled resonator can take input from a master circuit to coordinate the heating process across stages. In one embodiment, a circuit may be formed across individually controlled dynamically controlled resonators, where each resonator corresponds to an independent vessel. As part of the control process a multi-position valve may direct feedstock to a corresponding independent vessel, whereby each independent vessel could be optimized for a particular type of microwave or RF process. The vessels can be optimized for variants of pyrolysis and gasification processes which will result in different amounts and types of gas, liquid and char content based on heating rate, time and temperature range among other factors. Each resonator in the independent vessel is dynamically controlled for a specific process, while a master circuit coordinates the overall flow of the process.

The use of a resonator architecture that is dynamically controlled further extends the advantages in terms of reaction rate, heating uniformity, temperature range and control over residence time. In addition the control aspects enable the system to apply to industrial scale in terms of capacity, throughput and control.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a block diagram of a system for rapid and efficient reaction of a feedstock material with the presence of any type of gas or under vacuum using an electromagnetic resonator. This system may be used to perform plasma heating including plasma pyrolysis, plasma gasification, or plasma incineration of feedstock, biomass or waste material.

FIG. 2 is a block diagram of a system for rapid and efficient reaction of a feedstock material in air or under vacuum using an electromagnetic resonator. This system may also be used to perform pyrolysis, gasification, and incineration of feedstock, biomass or waste material.

FIG. 3 is a block diagram of a generic electromagnetic resonator coupling electromagnetic energy to a reaction zone using both inductive and capacitive coupling.

FIG. 4 is a block diagram of a generic electromagnetic resonator coupling electromagnetic energy to a reaction zone using inductive coupling.

FIG. 5 is a block diagram of a generic electromagnetic resonator coupling electromagnetic energy to a reaction zone using capacitive coupling.

FIG. 6A is a schematic of a cylindrical electromagnetic resonator coupling electromagnetic energy to a reaction zone.

FIG. 6B is a cross-sectional view of the electromagnetic resonator in FIG. 6A.

FIG. 7A is a schematic of a rectangular electromagnetic resonator coupling electromagnetic energy to a reaction zone.

FIG. 7B is a cross-sectional view of the electromagnetic resonator in FIG. 7A.

FIG. 8 is a schematic of two cylindrical electromagnetic resonators in series to form two reaction zones along the length of a feedstock tube.

FIG. 9 is a schematic of three cylindrical electromagnetic resonators in parallel forming three reaction zones along branches of a feedstock tube.

FIG. 10A is a schematic of a cylindrical electromagnetic resonator with an amplifier and feedback to form an oscillator.

FIG. 10B is a 3-dimensional perspective of the cylindrical electromagnetic resonator in FIG. 10A.

FIG. 10C is a cross-sectional view of the cylindrical resonator in FIG. 10B; the direction of the cross-section is as shown in FIG. 10B.

FIG. 10D is an elevation view of the cylindrical resonator in FIG. 10B; the direction of viewing is as shown in FIG. 10B.

FIG. 10E is a plan view of the cylindrical resonator in FIG. 10B; the direction of viewing is as shown in FIG. 10B.

FIG. 10F is a plan view of the cylindrical resonator in FIG. 10B; the direction of viewing is as shown in FIG. 10B.

FIG. 11A is a 3-dimensional perspective of a cylindrical electromagnetic resonator with the RF input feed probe connected to the ground at the end of the probe.

FIG. 11B is a cross-sectional view of the cylindrical resonator in FIG. 11A; the direction of the cross-section is as shown in FIG. 11A.

FIG. 11C is an elevation view of the cylindrical resonator in FIG. 11A; the direction of viewing is as shown in FIG. 11A.

FIG. 11D is a plan view of the cylindrical resonator in FIG. 11A; the direction of viewing is as shown in FIG. 11A.

FIG. 11E is a plan view of the cylindrical resonator in FIG. 11A; the direction of viewing is as shown in FIG. 11A.

FIG. 12A is a 3-dimensional perspective of a cylindrical type electromagnetic resonator with a modified design to concentrate the electric field of the resonator across the reactor tube.

FIG. 12B is a cross-sectional view of the cylindrical resonator in FIG. 12A; the direction of the cross-section is as shown in FIG. 12A.

FIG. 12C is an elevation view of the cylindrical resonator in FIG. 12A; the direction of viewing is as shown in FIG. 12A.

FIG. 12D is a plan view of the cylindrical resonator in FIG. 12A; the direction of viewing is as shown in FIG. 12A.

FIG. 12E is a plan view of the cylindrical resonator in FIG. 12A; the direction of viewing is as shown in FIG. 12A.

FIG. 13A is a 3-dimensional perspective of a cylindrical electromagnetic resonator which is partially filled with a dielectric material.

FIG. 13B is a cross-sectional view of the cylindrical resonator in FIG. 13A; the direction of the cross-section is as shown in FIG. 13A.

FIG. 13C is an elevation view of the cylindrical resonator in FIG. 13A; the direction of viewing is as shown in FIG. 13A.

FIG. 13D is a plan view of the cylindrical resonator in FIG. 13A; the direction of viewing is as shown in FIG. 13A.

FIG. 13E is a plan view of the cylindrical resonator in FIG. 13A; the direction of viewing is as shown in FIG. 13A.

FIG. 14 depicts the cylindrical electromagnetic resonator in FIG. 11A including dynamic feedback to optimize resonator impedance match to the material being heated.

FIG. 15 depicts the cylindrical electromagnetic resonator in FIG. 11A including dynamic feedback to optimize the resonator impedance match to the material being heated by adjusting the plasma density.

### DETAILED DESCRIPTION

In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to obscure the present invention. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

Embodiments of the present invention relate to efficient reaction of materials using electromagnetic resonators. Embodiments of the invention may be applied more particularly to efficient pyrolysis, gasification, incineration (or other similar processes) of feedstock including but not limited to biomass, petroleum, petcoke, industrial chemicals and waste materials using RF resonators and adaptively tunable RF resonators.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the Claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

### Glossary

Before describing the specific details of the present invention, a glossary is provided in which various terms used herein and in the claims are defined. The glossary provided is intended to provide the reader with a general understanding of the intended meaning of the terms, but is not intended to convey the entire scope of each term. Rather, the glossary is intended to supplement the rest of the specification in more accurately explaining the terms used.

Feedstock—The term in this patent refers to any material subject to a reaction driven by electromagnetic energy concentrated within the resonator. Examples of feedstock described herein include, but are not limited to, biomass, petroleum, industrial chemicals and waste materials.

Quality Factor (Q)—The term “quality factor” or “Q” as used with respect to embodiments of this invention refers to the property of a resonator that determines how well a resonator stores energy or how lossy a resonator is. A higher Q resonator stores energy better and has a lower loss than a lower Q resonator.

Coupling capacitor—The term “coupling capacitor” as used with respect to embodiments of this invention refers to an RF/microwave structure (or compound structure comprising two or more RF/microwave elements) having an effective impedance dominated by an effective capacitance. This effective capacitance can be used to couple electromagnetic energy between elements of a system, e.g., between a source of electromagnetic energy and a resonator.

Distributed Structure—The term “distributed structure” as used with respect to embodiments of this invention refers to an RF/microwave structure, a characteristic dimension of which is comparable to a wavelength of electromagnetic radiation from a source of such radiation. By way of example, and not by way of limitation, the characteristic dimension may be a length of a transmission line or a resonator.

E-field probe—The term “e-field probe” or “E-field probe” as used with respect to embodiments of this invention refers to any means of coupling electromagnetic energy that couples substantially more energy from interaction with the electric field than interaction with the magnetic field.

Feedback-induced Oscillations—The term “feedback-induced oscillations” as used with respect to embodiments of this invention refers to feeding back (in an additive sense/substantially in-phase) part of the output power of an amplifier into the input of the amplifier with sufficient gain on the positive-feedback to make the amplifier oscillate.

H-field probe—The term “h-field probe” or “H-field probe” as used with respect to embodiments of this invention refers to any means of coupling electromagnetic energy that couples substantially more energy from interaction with the magnetic field than from interaction with the electric field.

Lumped Circuit—The term “lumped circuit” as used with respect to embodiments of this invention refers to a circuit comprising actual resistors, capacitors and inductors as opposed to, for example, a transmission line or a dielectric resonator (circuit components that are comparable in size to the wavelength of the RF source).

Lumped Parallel Oscillator—The term “lumped parallel oscillator” as used with respect to this invention refers to resistors, capacitors, and inductors that are connected in parallel to form a resonator.

### Specific Aspects

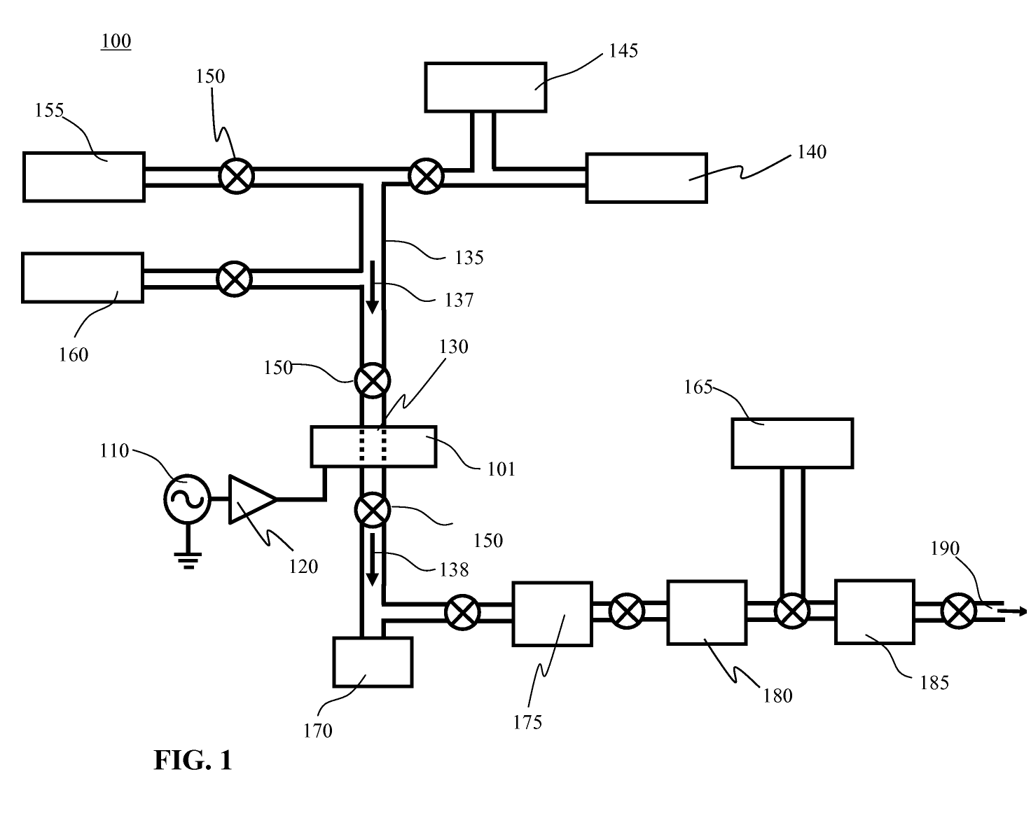

FIG. 1 is a block diagram of a system 100 for rapid and efficient heating of any material with the presence of any type of gas or under vacuum using an electromagnetic resonator in a continuous or semi-continuous process. The system 100 may include a feed hopper 145 that contains the feedstock to be heated, a screw feeder 140 that pushes the feedstock through tubing 135 that connects various parts of the system. A section of the tubing 135 passes through the center of a cylindrical electromagnetic resonator 101. An electromagnetic oscillator 110 and electromagnetic amplifier 120 apply electromagnetic energy to the resonator 101. By way of example, and not by way of limitation, the electromagnetic energy may be characterized by an oscillation frequency in the sub-radiofrequency to microwave range of the electromagnetic spectrum (e.g., from about 10 MHz to about 10 GHz). The tubing 135 can be made (depending on the feedstock) from a number of different materials including metal, glass, quartz or ceramic but the section of the tubing that passes through the center of the resonator to form a reaction zone 130 has to be made from a material that is transparent to radiation in the frequency range produced by the oscillator 110. For example, in the case of an RF oscillator 110, the portion of the tubing 135 that forms the reaction zone 130 may be made of an RF transparent or low-loss material such as quartz or alumina. The portion of the tubing 135 that passes through the resonator 101 is sometimes referred to herein as the feedstock tube. The feedstock material 137 flows into the reaction zone 130 with the heated byproducts 138 flow out of the reaction zone 130. The resonator 101 is optimized to have a maximum electric field where the feedstock tube 135 passes through the reaction zone 130 (e.g., at the center of the resonator) and to match the impedance of the electromagnetic source (which may include, the oscillator 110 and amplifier 120) to the impedance of the feedstock being heated. The resonator 101 may concentrate the RF electric field inside the feedstock 137 and impedance match to the feedstock 137 for efficient heating. In some versions, the resonator 101 may include an adjustable sized coupling aperture to facilitate adjustment of the electromagnetic power coupled to feedstock 137 in the reaction zone 130.

A number of valves 150 may be used at various locations along the tubing 135 to control flow of gases or materials as well as isolate various parts of the system. One or more vacuum pumps 160 and 165 may be used to evacuate the air from tubing and other parts of the system such that the heating of the feedstock can be carried in an Oxygen free or low Oxygen environment. A gas source 155 may be used to provide carrier gas (e.g., an inert gas such as Nitrogen or Argon) through the tubing to the reactor. At sufficiently high electromagnetic fields the Nitrogen or Argon may be ionized providing plasma that can be used for high temperature heat treatment of the feedstock such as plasma pyrolysis, plasma gasification or plasma incineration. Depending on the electromagnetic power used, design of the resonator, the size of the reactor, and use of plasma, temperature ranges of 100° C. to over 6000° C. can be achieved inside the reactor. Depending on the temperature in the reaction zone 130, as the feedstock 137 passes through the reactor it may be converted to other materials consisting of solid, liquid, and gas. Solid material may be collected in a trap 170. Liquids may be collected in a condenser 175 and gas, after passing through a buffer 180, may be collected in a gas container 185. Unwanted materials may be purged from the system through an exhaust 190.

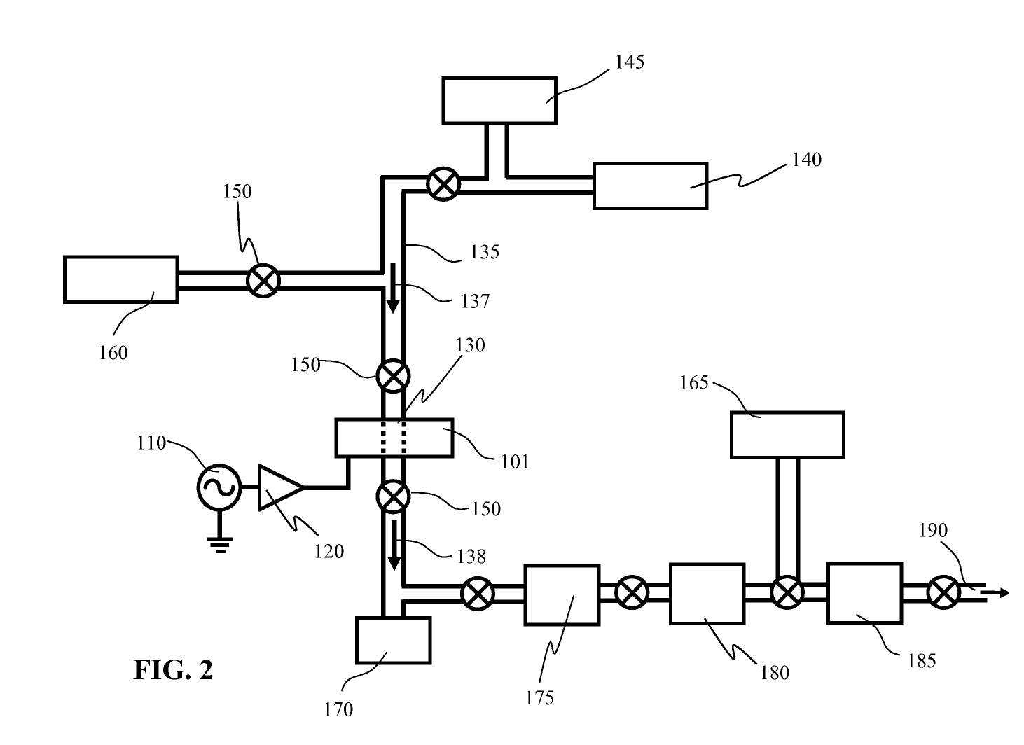

FIG. 2 is a block diagram of a system 102 for rapid and efficient reaction of any material in air or under vacuum using an electromagnetic resonator in a continuous or semi-continuous process. The system may include a feed hopper 145 that contains the feedstock to be heated, a screw feeder 140 that pushes the feedstock through tubing 135 that connects various parts of the system. A section of the tubing 135 passes through the center of a cylindrical electromagnetic resonator 101. By way of non-limiting example, the resonator 101 may be an RF resonator. An RF oscillator 110 and RF amplifier 120 apply RF energy to the RF resonator. The tubing 135 may be made (depending on the feedstock) from a number of different materials including metal, glass, quartz or ceramic but, in this example, the section of the tubing that passes through the center of the resonator to form a reaction zone 130 has to be made from an RF transparent or low-loss material such as quartz or alumina. The feedstock material 137 flows into the reaction zone 130 and reaction products 138 flow out of the reaction zone. The resonator 101 may be optimized to have a maximum electric field at its center where the tubing 135 passes through forming the reaction zone 130. The resonator may also be optimized to match the impedance of the RF source (including, e.g., the oscillator 110 and amplifier 120) to the impedance of the feedstock 137. The resonator 101 will concentrate the RF electric field inside the feedstock and impedance match to the feedstock for efficient heating. As in the system 100, a number of valves 150 may be used at various locations along the tubing to control the flow of air or materials as well as isolate various parts of the system. One or more vacuum pumps 160 and 165 are used to evacuate the air from tubing and other parts of the system such that the heating of the feedstock can be carried in an Oxygen free or low Oxygen environment. Depending on the RF power used, design of the resonator, and the size of the reactor, temperature ranges of 50° C. to over 1000° C. can be achieved inside the reactor. Depending on the temperature of the reactor as the feedstock passes through the reactor it is converted to other materials consisting of solid, liquid, and gas. The solid material may be collected in a trap 170, the liquid in condenser 175 and the gas after passing through the buffer 180 in the gas container 185. Unwanted materials may be purged through the system through the exhaust 190.

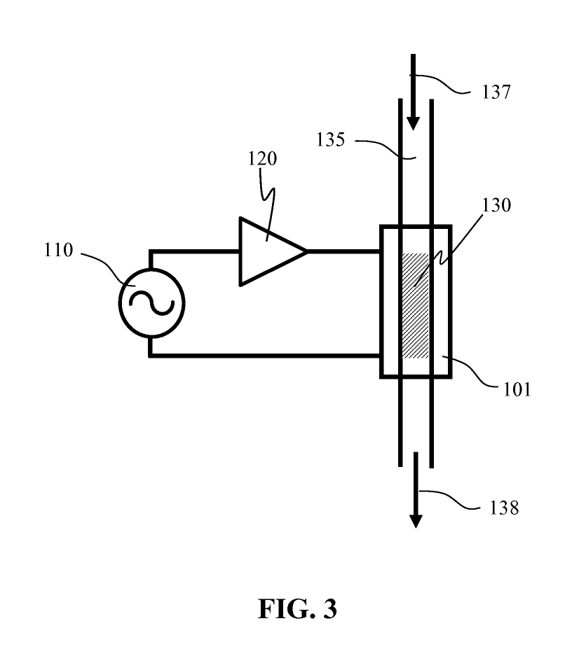

FIG. 3 is a block diagram of a generic electromagnetic resonator 101 coupling RF energy to a reaction zone 130. Electromagnetic energy in the form of an RF oscillator 110 couples from an RF signal is coupled to an RF amplifier 120 which amplifies the RF signal. The resulting amplified RF signal is coupled from the amplifier 120 to an electromagnetic resonator 101. The electromagnetic resonator 101 can be a lumped circuit or distributed circuit resonator. A tube 135 carries the feedstock to be heated by the RF energy. At least portion of the tube 135 is made from RF transparent or low-loss material such as quartz or alumina to form the reactor 130. The electromagnetic resonator is designed to impedance match the RF source to the feedstock inside the reactor for maximum energy transfer. The RF/microwave energy stored in the electromagnetic resonator 101 may be coupled to the reaction zone 130 using the electric field (E-field) or magnetic field (H-field) or a combination of both. The feedstock material 137 being heated flows into the reactor 130 and the heated by-products 138 flow out of the reactor.

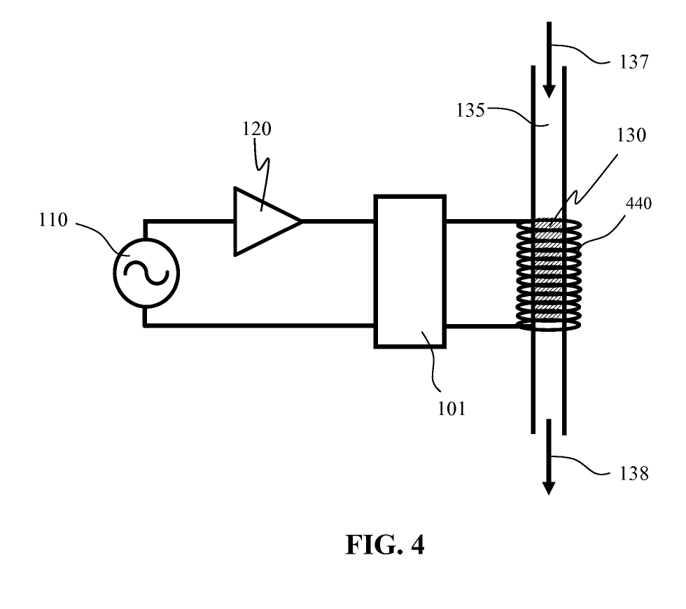

FIG. 4 is a block diagram of a generic electromagnetic resonator similar to the one shown in FIG. 3. An RF oscillator 110 couples an RF signal to an RF amplifier 120 which amplifies the RF signal that then it is coupled to an electromagnetic resonator 101. A tube 135 carries the feedstock to be heated by the RF energy. At least portion of the tube 135 is made from RF transparent or low-loss material such as quartz or alumina to form the reaction zone 130. The electromagnetic resonator is designed to impedance match the RF source to the feedstock inside the reactor for maximum energy transfer. The RF/microwave energy stored in the electromagnetic resonator 101 is coupled to the reactor 130 using inductive coupling. By way of example, the resonator 101 may be in the form of an electrically conductive coil that surrounds the portion of the tubing 135 that forms the reaction zone 130. Due to the coiled shape of the resonator, electromagnetic energy is primarily coupled to the reaction zone 130 inductively through large magnetic fields. The feedstock material 137 being heated flows into the reaction zone 130 and the heated by-products 138 flow out of the reaction zone 130.

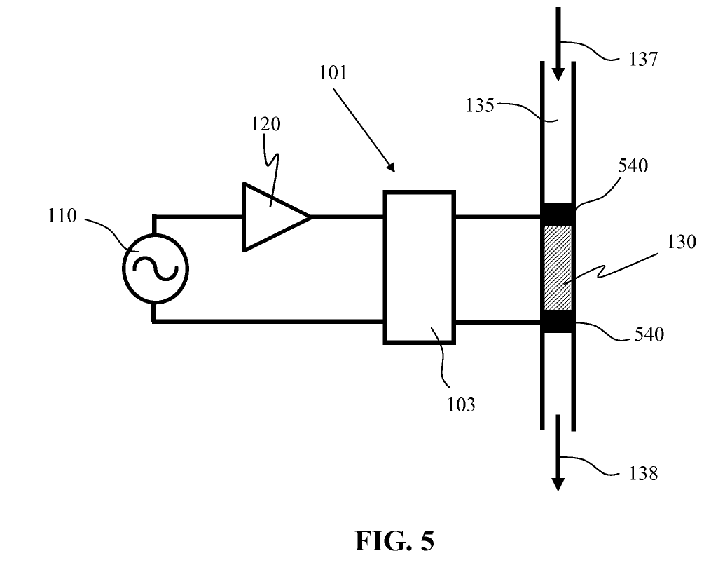

FIG. 5 is a block diagram of a generic electromagnetic resonator similar to the one shown in FIG. 3. An RF oscillator 110 couples energy to an RF amplifier 120 which amplifies the RF signal that then it is coupled to an electromagnetic resonator 101. A tube 135 carries the feedstock to be heated by the RF energy. At least portion of the tube 135 is made from RF transparent or low-loss material such as quartz or alumina to form the reactor 130. The electromagnetic resonator is designed to impedance match the RF source to the feedstock inside the reactor for maximum energy transfer. In this case the resonator 101 includes a coupling capacitor 103 connected to the oscillator 110 and amplifier 120 and spaced-apart electrodes 540 that are located outside the tubing 135 proximate the reaction zone 130. The RF/microwave energy stored in the electromagnetic resonator 101 gives rise to large electric fields and this electric field is coupled to the reactor 130 using capacitive coupling. The feedstock material 137 being heated flows into the reactor 130 and the heated by-products 138 flow out of the reactor.

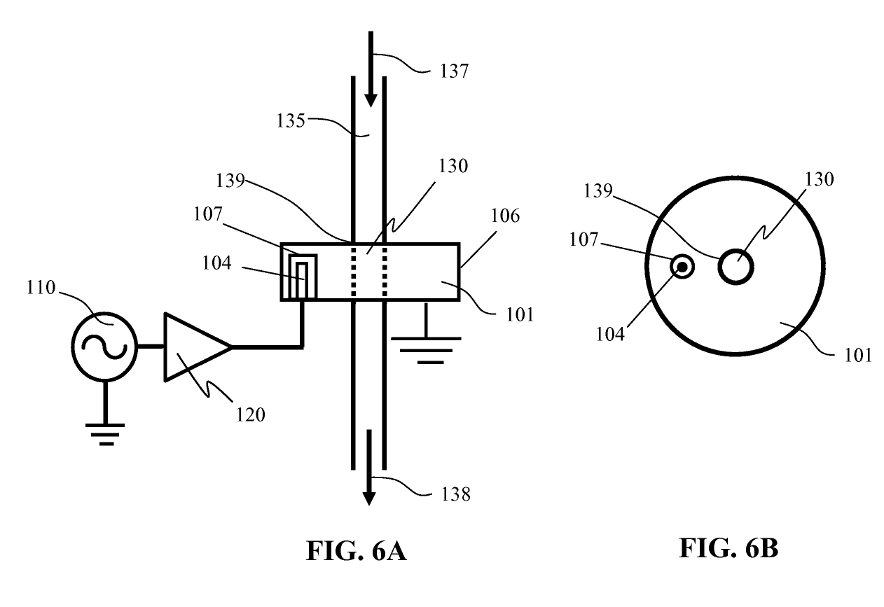

FIG. 6A is a schematic of a cylindrical electromagnetic resonator coupling RF energy efficiently to an RF transparent tube to form a reactor for heating materials. An RF oscillator 110 couples energy to an RF amplifier 120 which amplifies the RF signal that then it is coupled to a cylindrical electromagnetic resonator 101. The RF oscillator 110 and/or amplifier 120 may include one or more solid-state oscillators and amplifiers made from silicon based transistors such as LDMOS FETs or BJTs, or GaAs/GaN/SiC based FETs. Alternatively any other tube-based sources of RF, such as magnetrons, can be used. The frequency of the RF source, depending on the material being heated, can be from 10 MHz to 20 GHz. The cylindrical electromagnetic resonator 101 can be filled with air which has a dielectric constant of 1 or alternatively can be filled with other low-loss dielectric materials with dielectric constant of greater than 1 such as alumina. The output of the amplifier 120 is connected to an electrically conductive input E-field probe 104 to couple RF energy into the resonator 101. The resonator 101 may be covered with a conductive layer 106 connected to ground except for an area 107 around the input probe 104.

The cylindrical electromagnetic resonator can also be partially filled with one or more low-loss dielectric materials. For example the cylindrical resonator can be partially filled with air and partially filled with alumina. The cylindrical electromagnetic resonator may be designed such that the maximum electric field occurs at the center of the cylinder. At the center of the cylindrical electromagnetic resonator a hole 139 may be located so that the feedstock tube 135 can pass through the resonator. At least this portion of the tube is made from RF transparent or low-loss materials such as quartz or alumina to form the reaction zone 130. The cylindrical electromagnetic resonator 101 is designed to impedance match the RF source to the feedstock inside the reactor for maximum energy transfer. Factors that affect such impedance matching include the frequency of RF/microwave energy from the oscillator 110, the length and diameter of the resonator 101, the diameter of the hole 139, the material of the resonator 101 and feedstock tube 135, as well as the feedstock material itself. In addition, the dimensions of the input probe 104 and its location can be adjusted to optimize the impedance match to the feedstock material for maximum RF energy coupling. The RF/microwave energy stored in the electromagnetic resonator 101 gives rise to large electric and magnetic fields inside the feedstock which results in efficient heating of the feedstock. The feedstock material 137 flows into the reaction zone 130 and the reaction products 138 flow out of the reaction zone.

FIG. 6B is a cross-sectional view of the cylindrical electromagnetic resonator in FIG. 6A showing the hole 139 in the center of the resonator 101 for tube 130 that forms the reactor to pass through.

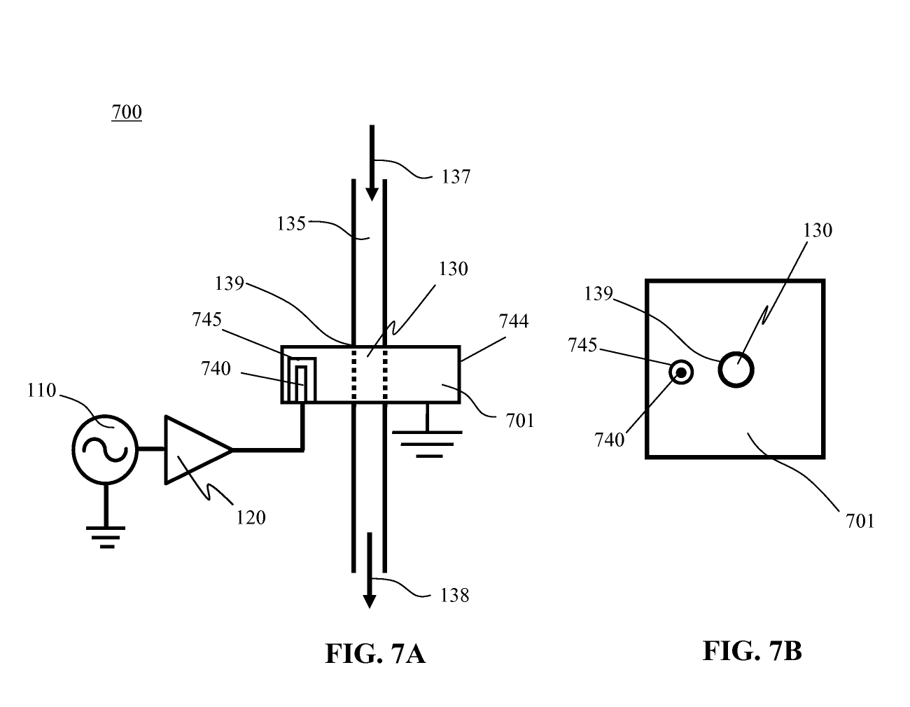

FIG. 7A is a schematic of a reaction system 700 that uses rectangular electromagnetic resonator 700 to couple RF energy efficiently to an RF transparent tube to form a reactor for heating materials. An RF oscillator 110 couples energy to an RF amplifier 120 which amplifies the RF signal that then it is coupled to a rectangular electromagnetic resonator 701. The RF oscillator 110 and/or amplifier 120 may include one or more solid-state oscillators and amplifiers made from silicon based transistors such as LDMOS FETs or BJTs, or GaAs/GaN/SiC based FETs. Alternatively any other tube-based sources of RF, such as magnetrons, can be used. The frequency of the RF source, depending on the material being heated, can be from 10 MHz to 20 GHz. The rectangular electromagnetic resonator may be filled with air which has a dielectric constant of 1 or alternatively can be filled with other low-loss dielectric materials with dielectric constant of greater than 1 such as alumina. The rectangular electromagnetic resonator may also be partially filled with one or more low-loss dielectric materials. For example the rectangular resonator may be partially filled with air and partially filled with alumina. The rectangular electromagnetic resonator is designed such that the maximum electric field occurs at the center of the rectangle (or square). At this center of the rectangular electromagnetic resonator a hole 139 may be located so that the feedstock tube 135 can pass through the resonator. At least this portion of the tube 135 is made from RF transparent or low-loss materials such as quartz or alumina to form the reaction zone 130. The rectangular electromagnetic resonator 701 is designed to impedance match the RF source to the feedstock inside the reactor for maximum energy transfer. The output of the amplifier 120 is connected to an electrically conductive input E-field probe 740 to couple RF energy into the resonator 701. The resonator 701 may be covered with a conductive layer 744 connected to ground except for an area 745 around the input probe 740. The RF/microwave energy stored in the electromagnetic resonator 700 gives rise to large electric and magnetic fields inside the feedstock which results in efficient heating of the feedstock. The feedstock material 137 being heated flows into the reactor 130 and the heated by-products 138 flow out of the reactor. Factors that affect such impedance matching include the frequency of RF/microwave energy from the oscillator 110, the length, width and thickness of the resonator 701, the diameter of the hole 139, the material of the resonator 700 and feedstock tube 135, as well as the feedstock material itself. In addition, the dimensions of the input probe 740 and its location can be adjusted to optimize the impedance match to the feedstock material for maximum RF energy coupling.

FIG. 7B is a cross-sectional view of the rectangular electromagnetic resonator in FIG. 7A showing the hole 139 in the resonator 701 for tube 135 that forms the reaction zone 130.

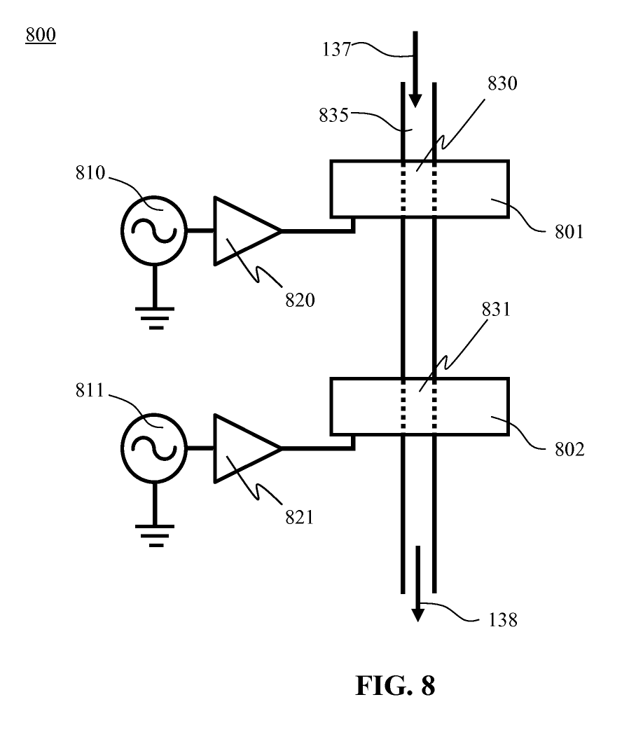

Embodiments of the present invention permit the possibility that combinations of two or more resonators may be used to process a feedstock. For example, FIG. 8 is a schematic showing a reaction system 800 having two cylindrical electromagnetic resonators 801 and 802 similar to the one depicted in FIG. 6A in series along the length of the feedstock tube 835 to form two reaction zones 830 and 831. RF sources 810 and 811 drive RF amplifiers 820 and 821 which then drive resonators 801 and 802 respectively. The feedstock material 137 flows into reaction zone 830. Intermediate reaction products produced in reaction zone 830 flow from reaction zone 830 into reaction zone 831. Reaction products 138 produced in the second reaction zone 831 flow out of the second reaction zone 831. Two or more identical resonators can be used for further heat treatment of the feedstock as it continuously passes through the tube. In some cases as the feedstock is heat treated its dielectric properties may change and as a result its impedance changes. This may require a change in the resonator design to optimally impedance match the source impedance to the heat-treated feedstock. So the resonators in series can be designed such that each may be optimized for impedance matching to feedstock at different stages of its heat treatment.

In some cases various types of feedstock with different composition and therefore different dielectric properties have to be heat treated as they pass through the tube. In this case the resonators in series can be designed differently such that each resonator optimally impedance matches the electromagnetic source to a different type of feedstock.

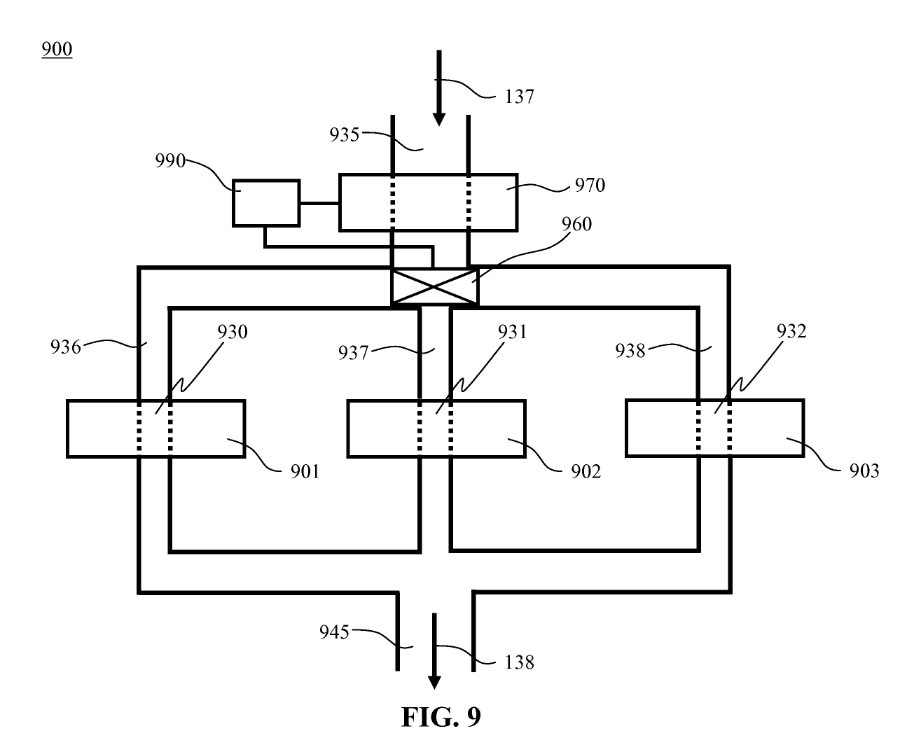

FIG. 9 is a schematic of a feedstock reaction system 900 having three cylindrical electromagnetic resonators 901, 902, and 903, similar to the resonator shown in FIG. 6A, in parallel forming three reaction zones 930, 931, and 932 respectively. To simplify illustration, the RF sources and the RF amplifiers driving each resonator are not shown in the FIG. 9. However, these features, which are shown in FIG. 6A, may be incorporated into embodiments of the invention depicted in FIG. 9. The feedstock material 137 flows into an incoming feedstock tube 935. The incoming feedstock tube 935 is split into three branch tubes 936, 937, and 938. The branch tubes 936, 937, 938 pass through the centers of resonators 901, 902, and 903 respectively and then recombine into an output tube 945. The reaction products formed in reaction zones 930, 931, and 932 flow out of the branch tubes 936, 937 and 938 respectively into output tube 945. Using three or more identical resonators in parallel allows increasing the throughput of a feedstock processing system. In some cases various types of feedstock with different compositions and therefore different dielectric properties may have to be heat treated as they pass through the tube. In this case the resonators in parallel may be designed differently such that each resonator optimally impedance matches the RF source to a different type of feedstock. As the feedstock passes through tube 935 a separate RF resonator 970 using a low power RF source may be used to assess the dielectric properties of the feedstock and determine which one of the other resonators 901, 902, or 903 will have the optimum impedance match to heat the feedstock. This information may be fed to a microcontroller 990 that controls a multi-position valve 960 that then sends the feedstock towards the resonator with the optimum impedance match for heating that feedstock. Instead of using resonator 970 to characterize the dielectric properties of feedstock, other techniques such as spectroscopy can be used to characterize the feedstock to determine the optimum resonator for heating the feedstock.

It is also possible to combine resonators both in series, as shown in FIG. 8 and in parallel, as shown in FIG. 9, in the same system to simultaneously increase throughput, process different types of feedstock, as well as optimally process the feedstock at various stages of heat treatment.

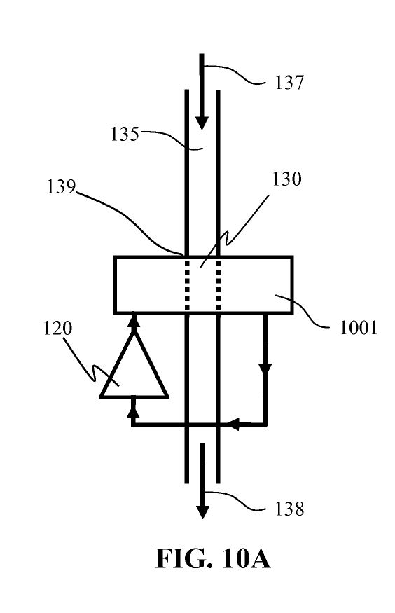

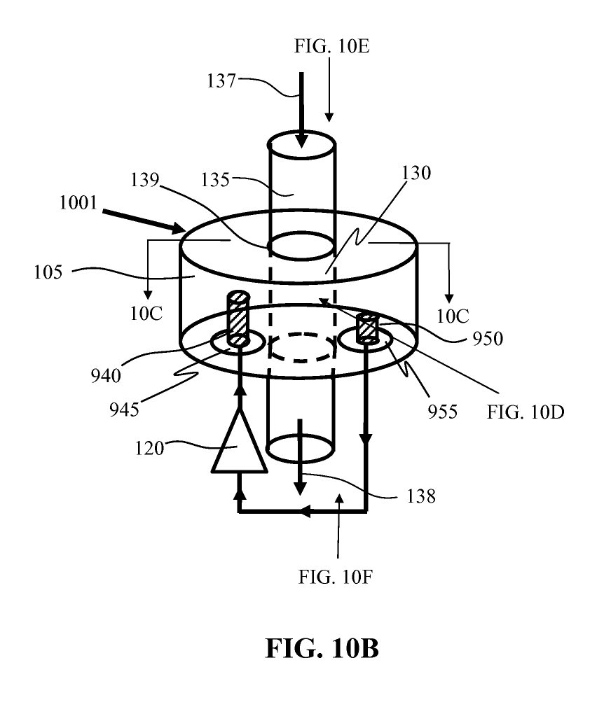

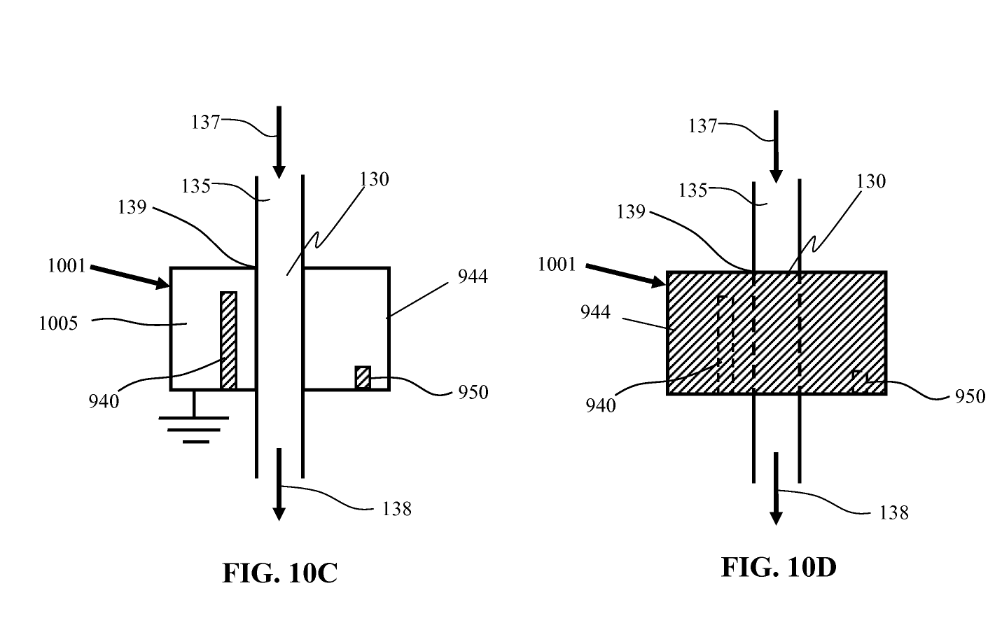

There are a number of different possible resonator configurations that may be used in conjunction with embodiments of the present invention. One alternative resonator configuration is depicted in FIGS. 10A-10F. FIG. 10A is a schematic of a reaction system that uses a cylindrical electromagnetic resonator 1001 similar to the resonator in FIG. 6A except an amplifier is used with feedback to form an oscillator. In this configuration instead of direct driving the resonator 1001 using an oscillator 110 (shown in FIG. 6A) and an amplifier 120, a small amount of power from the resonator may be fed into the input of the amplifier 120 to provide feedback. The output of the amplifier 120 is coupled to the resonator. This configuration forms an oscillator which directly provides RF power to the resonator. The dimensions and dielectric properties of the resonator, the feedback loop, as well as amplifier gain and bandwidth determine the resonant frequency of the oscillator. At the center of the cylindrical electromagnetic resonator a hole is located 139 for the feedstock tube 135 to pass through the resonator. At least this portion of the tube 135 is made from RF transparent or low-loss materials such as quartz or alumina to form the reaction zone 130. The cylindrical electromagnetic resonator is designed to impedance match the RF source to the feedstock inside the reactor for maximum energy transfer. The RF/microwave energy stored in the electromagnetic resonator 1001 gives rise to large electric and magnetic fields inside the feedstock which results in efficient heating of the feedstock. The feedstock material 137 flows into the reaction zone 130 and the reaction products 138 flow out of the reaction zone. Depending on the dielectric properties of the feedstock material 137 the resonant frequency of the resonator 1001 may change as the material passes through the center of the resonator. Using a feedback oscillator configuration the frequency of the amplifier 120 can change to match the resonant frequency of the resonator resulting in maintaining maximum electric field in the reaction zone 130. This applies as long as the bandwidth of the amplifier is within the range of change in the resonant frequency of the resonator. As the feedstock 137 is heated or otherwise reacts as a result of electromagnetic energy from the resonator 1001 the dielectric properties of the feedstock 137 may change, thereby causing a shift in resonant frequency of the resonator. Using a feedback oscillator configuration it is possible to maintain resonance, maximizing electric field in the reactor, resulting in continuous efficient heating of the feedstock.

FIG. 10B is a 3-dimensional schematic diagram showing a possible configuration of the cylindrical electromagnetic resonator 1001 depicted in FIG. 10A. The cylindrical resonator 1001 has a hole in the middle 139 for a tube 135 to pass through the center of the resonator. At least portion of the tube 135 is made from an RF transparent or low-loss material such as quartz or alumina to form the reactor 130. A feedback probe 950 is used to couple a small amount of RF energy out of the resonator to feed into the amplifier 120. The output of the amplifier is connected to an electrically conductive input E-field probe 940 to couple RF energy into the resonator. The dimensions of the input probe 940 and its location can be adjusted to optimize the impedance match to the feedstock material for maximum RF energy coupling. The resonator 1001 is covered with a conductive layer 944 connected to ground except for areas 945 and 955 around the feedback probe and input probe. The inside 1005 of the resonator 1001 can be filled with air or with a dielectric material such as alumina.

FIG. 10C is a cross-sectional view of the cylindrical resonator in FIG. 10B; the direction of the cross-section is as shown in FIG. 10B. The cross-section shows the tube 135 passing through the hole 139 in the center of the cylindrical resonator 101 to form the reactor 130. The feedback probe 950 couples a small amount of energy out of the resonator and the input probe 940 couples RF energy into the resonator. The amplifier 120 is not shown in FIG. 10D for the sake of clarity.

FIG. 10D is an elevation view of the cylindrical resonator in FIG. 10B; the direction of viewing is as shown in FIG. 10B. The elevation view displays the conductive layer 944 covering the cylindrical resonator 1001 with diagonal cross-hatching.

FIG. 10E is a plan view of the cylindrical resonator in FIG. 10B; the direction of viewing is as shown in FIG. 10B. The plan view displays the opening 139 at the center of the cylindrical resonator 1001 for the feedstock tube to pass through forming the reactor 130. The resonator is covered with a conductive layer 944 except for the center hole 130 and the areas around the probes 945 and 955. Also shown (hidden from view) are the feedback probe 950 and input probe 940.

FIG. 10F is a plan view of the cylindrical resonator in FIG. 10B; the direction of viewing is as shown in FIG. 10B. The plan view displays the opening 139 at the center of the cylindrical resonator 1001 for the feedstock tube to pass through forming the reactor 130. Also shown are the feedback probe 950 and input probe 940. The resonator is covered with a conductive layer except for the center hole 130 and the areas around the probes 945 and 955.

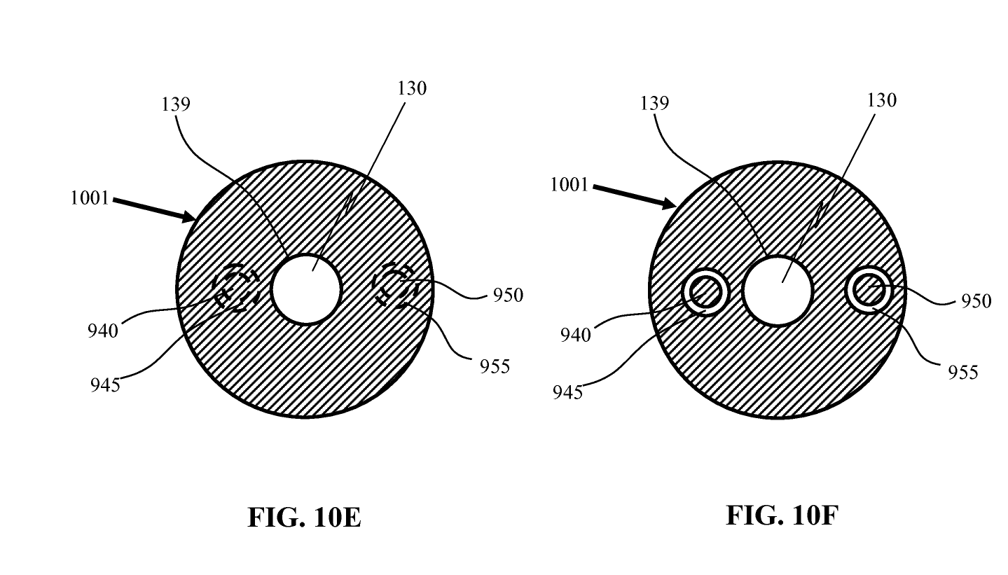

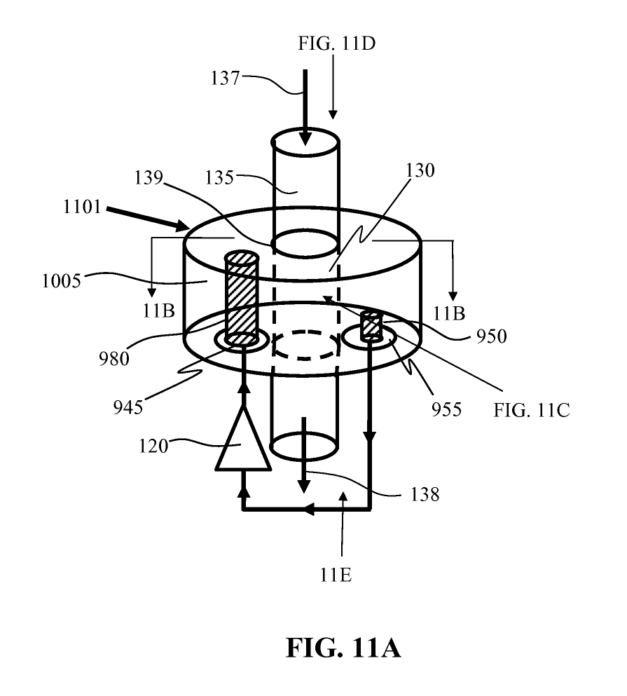

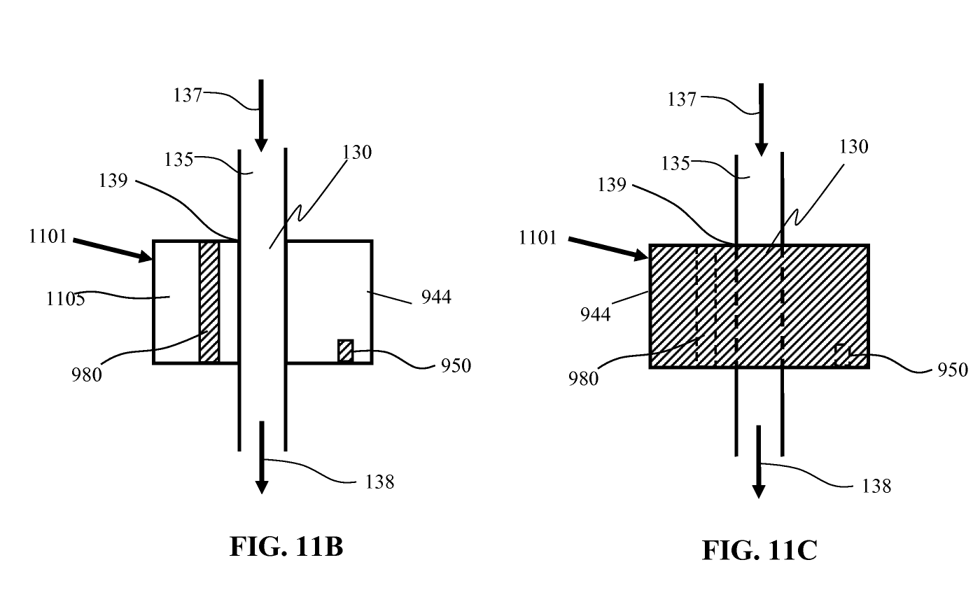

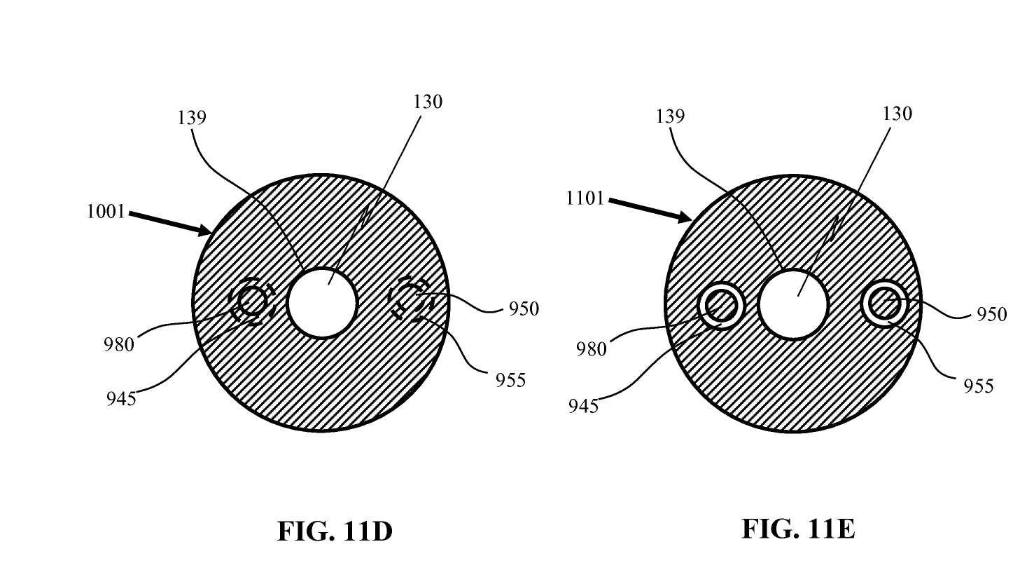

Another alternative resonator configuration is depicted in FIGS. 11A-11E. FIG. 11A is a 3-dimensional perspective of a cylindrical electromagnetic resonator 1101 similar to the one depicted in FIG. 10B. A cylindrical resonator 1101 has a hole in the middle 139 for a tube 135 to pass through the center of the resonator. At least this portion of the tube 135 is made from an RF transparent or low-loss material such as quartz or alumina to form the reaction zone 130. The feedstock material 137 flows into the reaction zone 130 and the reaction products 138 flow out of the reaction zone. A feedback probe 950 is used to couple a small amount of RF energy out of the resonator to feed into the amplifier 120. The output of the amplifier 120 is connected to the input E-field probe 980 to couple RF energy into the resonator. The resonator is covered with a conductive layer 944 connected to ground except for areas 945 and 955 around the feedback probe and input probe. The end of the RF input feed probe 980 is connected to the grounded conductive layer 944 that covers the resonator 1101. The use of a grounded probe 980 allows a more compact resonator design and more concentration of the electric field. The dimensions of the input probe 980 and its location can be adjusted to optimize the impedance match to the feedstock material for maximum RF energy coupling. The inside 1105 of the resonator 1101 can be filled with air or with a dielectric material such as alumina.

FIG. 11B is a cross-sectional view of the cylindrical resonator in FIG. 11A; the direction of the cross-section is as shown in FIG. 11A. The cross-section shows the tube 135 passing through the hole 139 in the center of the cylindrical resonator 1101 to form the reaction zone 130. The feedback probe 950 couples a small amount of energy out of the resonator and the input probe 980 couples RF energy into the resonator. The end of the input probe 980 passes completely through the resonator connecting to the grounded conductive layer 944 covering the resonator. The amplifier 120 is not shown in FIG. 11B for the sake of clarity of illustration.

FIG. 11C is an elevation view of the cylindrical resonator in FIG. 11A; the direction of viewing is as shown in FIG. 11A. The elevation view displays the conductive layer covering the cylindrical resonator 1101.

FIG. 11D is a plan view of the cylindrical resonator in FIG. 11A; the direction of viewing is as shown in FIG. 11A. The plan view displays the opening 139 at the center of the cylindrical resonator 1101 for the feedstock tube to pass through forming the reactor 130. The resonator 1101 is covered with a conductive layer 944 except for the center hole 139 and the areas around the probes 945 and 955. Also shown (hidden from view) are the feedback probe 950 and input probe 980.

FIG. 11E is a plan view of the cylindrical resonator in FIG. 11A; the direction of viewing is as shown in FIG. 11A. The plan view displays the opening 139 at the center of the cylindrical resonator 1101 for the feedstock tube to pass through forming the reactor 130. Also shown are the feedback probe 950 and input probe 980. The resonator is covered with a conductive layer except for the center hole 130 and the areas around the probes 945 and 955.

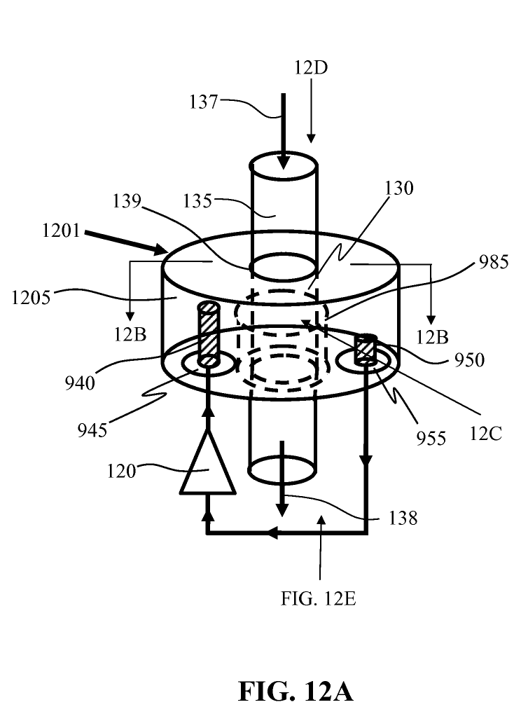

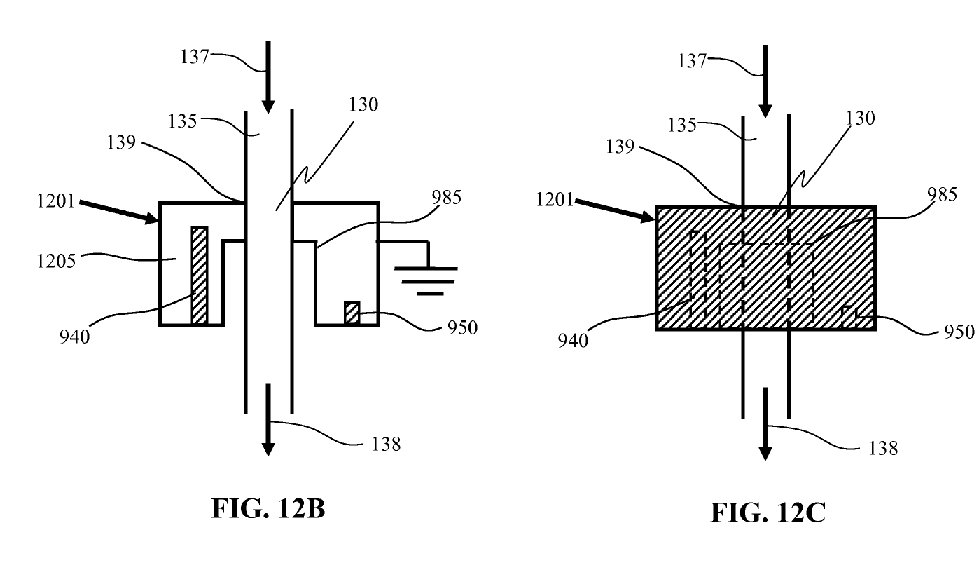

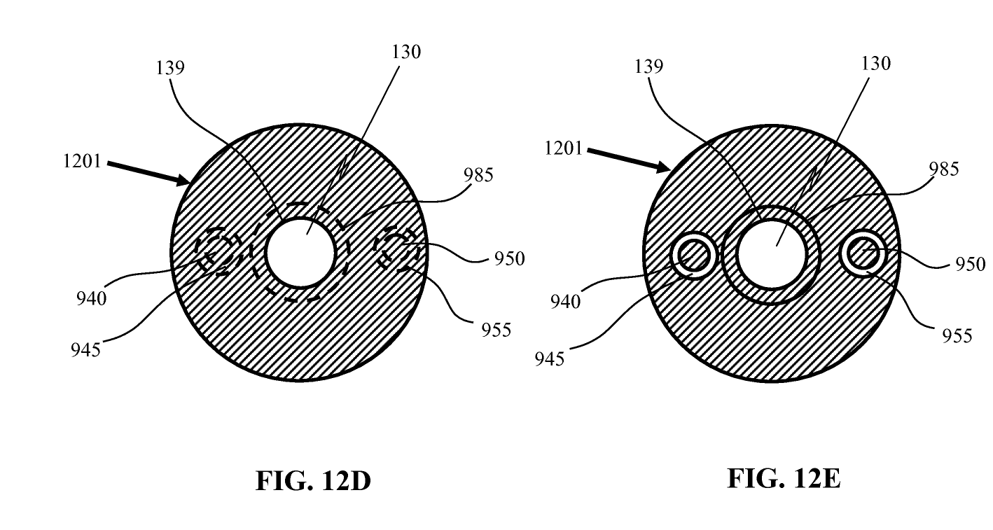

Another alternative resonator configuration is depicted in FIGS. 12A-12E. FIG. 12A is a 3-dimensional perspective of a cylindrical type electromagnetic resonator with a modified design to concentrate the electric field of the resonator across the reaction zone. A cylindrical resonator 1201 has a hole in the middle 139 for a tube 135 to pass through the center of the resonator. At least this portion of the tube 135 is made from an RF transparent or low-loss material such as quartz or alumina to form the reaction zone 130. A second hole 985 with a larger diameter than 139 is made from the back of the resonator 1201 but this hole only partially goes into the resonator. The resonator is covered with a conductive layer connected to ground, including inside the hole 985, except for areas 945 and 955 around the feedback probe and input probe. The presence of hole 985 effectively increases the capacitance of the resonator allowing design of more compact resonators and at the same time concentrates the electric field across the reaction zone 130. The feedstock material 137 being heated flows into the reaction zone 130 and the heated by-products 138 flow out of the reactor. A feedback probe 950 is used to couple a small amount of RF energy out of the resonator to feed into the amplifier 120. The output of the amplifier is connected to the input E-field probe 940 to couple RF energy into the resonator. The dimensions of the input probe 940 and its location can be adjusted to optimize the impedance match to the feedstock material for maximum RF energy coupling. The inside 1205 of the resonator 1201 can be filled with air or with a dielectric material such as alumina.

FIG. 12B is a cross-sectional view of the cylindrical resonator in FIG. 12A; the direction of the cross-section is as shown in FIG. 12A. The cross-section shows the tube 135 passing through the hole 139 in the center of the cylindrical resonator 101 to form the reactor 130. The second hole 985 through the back with a conductive layer covering its surface helps to concentrate the electric field in the reactor. In addition this hole increases the internal capacitance of the resonator allowing more compact resonator designs. The feedback probe 950 couples a small amount of energy out of the resonator and the input probe 940 couples RF energy into the resonator. The amplifier 120 is not shown in FIG. 12B.

FIG. 12C is an elevation view of the cylindrical resonator in FIG. 12A; the direction of viewing is as shown in FIG. 12A. The elevation view displays the conductive layer covering the cylindrical resonator 1201.

FIG. 12D is a plan view of the cylindrical resonator in FIG. 12A; the direction of viewing is as shown in FIG. 12A. The plan view displays the opening 139 at the center of the cylindrical resonator 1201 for the feedstock tube to pass through forming the reaction zone 130. The resonator is covered with a conductive layer except for the center hole 139 and the areas around the probes 945 and 955. Also shown (hidden from view) are the feedback probe 950 and input probe 940.

FIG. 12E is a plan view of the cylindrical resonator in FIG. 12A; the direction of viewing is as shown in FIG. 12A. The plan view displays the opening 139 at the center of the cylindrical resonator 101 for the feedstock tube to pass through forming the reactor 130. Also shown are the feedback probe 950 and input probe 940. The resonator is covered with a conductive layer except for the center hole 139 and the areas around the probes 945 and 955.

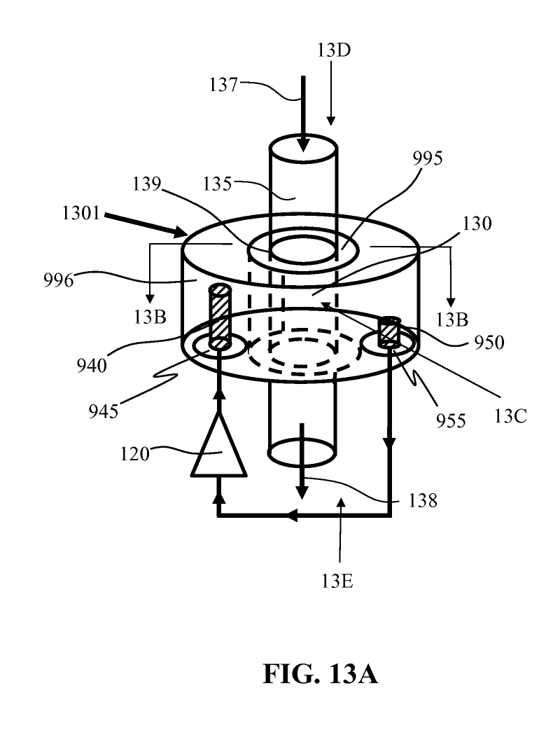

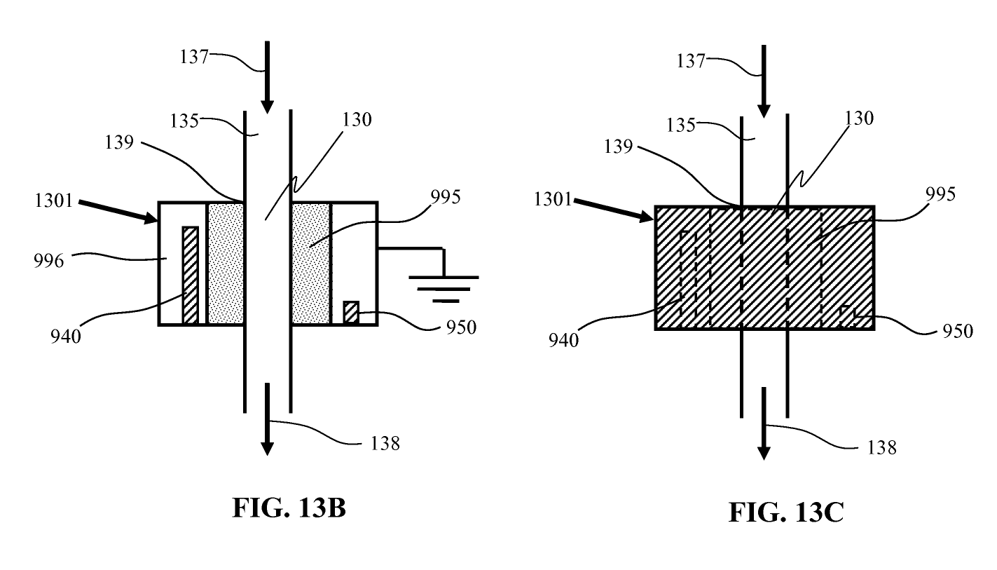

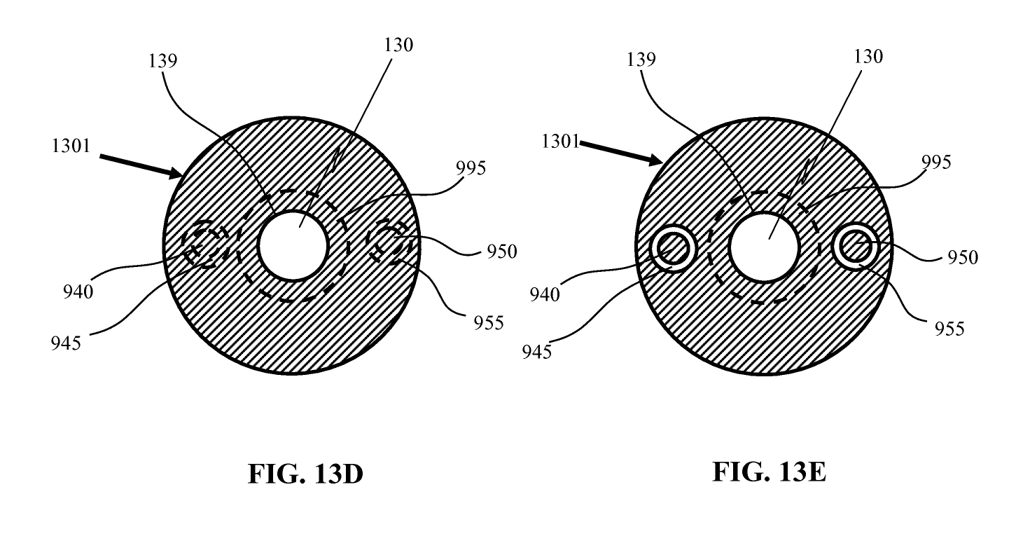

Another alternative resonator is depicted in FIGS. 13A-13E. FIG. 13A is a 3-dimensional perspective of a cylindrical electromagnetic resonator which is partially filled with a dielectric material. A cylindrical resonator 1301 has a hole in the middle 139 for a tube 135 to pass through the center of the resonator. At least this portion of the tube 135 is made from an RF transparent or low-loss material such as quartz or alumina to form the reaction zone 130. The resonator is covered with a conductive layer connected to ground except for areas 945 and 955 around the feedback probe and input probe. The feedstock material 137 flows into the reaction zone 130 and the heated by-products 138 flow out of the reactor. A feedback probe 950 is used to couple a small amount of RF energy out of the resonator to feed into the amplifier 120. The output of the amplifier is connected to the input E-field probe 940 to couple RF energy into the resonator. The dimensions of the input probe 940 and its location can be adjusted to optimize the impedance match to the feedstock material for maximum RF energy coupling. The inside of the resonator 996 can be partially filled with air and partially filled 995 with a dielectric material such as alumina.

FIG. 13B is a cross-sectional view of the cylindrical resonator in FIG. 13A; the direction of the cross-section is as shown in FIG. 13A. The cross-section shows the tube 135 passing through the hole 139 in the center of the cylindrical resonator 101 to form the reaction zone 130. The inside 996 of the resonator 1301 is partially filled with air and partially filled with a dielectric material 995 such as alumina. The feedback probe 950 couples a small amount of energy out of the resonator and the input probe 940 couples RF energy into the resonator. The amplifier 120 is not shown in the Figure.

FIG. 13C is an elevation view of the cylindrical resonator in FIG. 13A; the direction of viewing is as shown in FIG. 13A. The elevation view displays the conductive layer covering the cylindrical resonator 1301.

FIG. 13D is a plan view of the cylindrical resonator in FIG. 13A; the direction of viewing is as shown in FIG. 13A. The plan view displays the opening 139 at the center of the cylindrical resonator 1301 for the feedstock tube to pass through forming the reaction zone 130. The resonator is covered with a conductive layer except for the center hole 130 and the areas around the probes 945 and 955. Also shown (hidden from view) are the feedback probe 950 and input probe 940.

FIG. 13E is a plan view of the cylindrical resonator in FIG. 13A; the direction of viewing is as shown in FIG. 13A. The plan view displays the opening 139 at the center of the cylindrical resonator 1301 for the feedstock tube to pass through forming the reaction zone 130. Also shown are the feedback probe 950 and input probe 940. The resonator is covered with a conductive layer except for the center hole 130 and the areas around the probes 945 and 955.

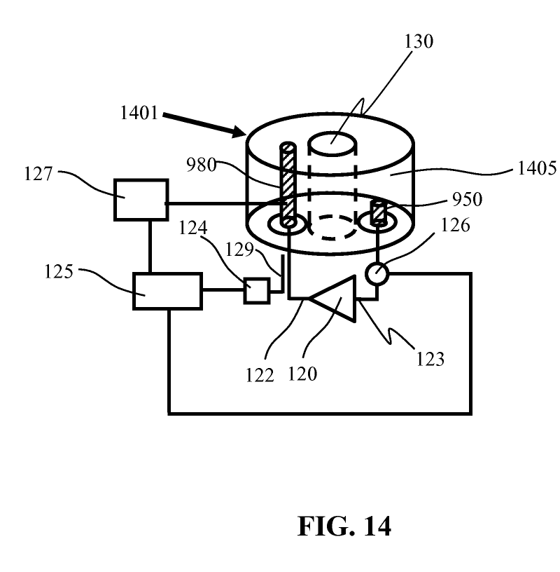

FIG. 14 depicts a cylindrical electromagnetic resonator of the type shown in FIG. 11A-11E including dynamic feedback to optimize resonator impedance match to the material being heated as well as adjust the resonant frequency of the resonator. Similar to FIG. 11A a cylindrical resonator 1401 has a hole in the center for a tube that is RF transparent or has low RF loss, to pass through forming reaction zone 130. The inside 1405 of the resonator 1401 can be filled with air or other low-loss dielectric materials. Alternatively the inside of resonator can be filled with multiple low-loss dielectric materials including low-loss liquids. The feedback probe 950 is used to couple a small amount of RF energy from the resonator to feed into a phase shifter 126 and then to the input 123 of the amplifier 120. The output 122 of the amplifier 120 is connected to an RF coupler 129 which then is connected to input RF probe 980. The position of the input RF probe 980 can be adjusted using a micropositioner 127. The coupler 129 is used to measure the reflected RF power from the resonator using RF detector 124. The output of the RF detector is fed into a microcontroller 125. As the feedstock material passes through the center of the cylindrical resonator (or as the feedstock material is being heated changing its dielectric properties) the resonant frequency of the cylindrical resonator may change as well as the optimum impedance match for maximum energy transfer to the feedstock changes. The change in resonant frequency typically results in an increase of reflected power from the resonator measured by RF detector 124. Microcontroller 125 may be configured to dynamically adjust the phase shifter 126 and micropositioner 127 to minimize the reflected power and maximize the RF power coupled to the feedstock resulting in very efficient continuous heating of feedstock. In some cases such as the one shown in FIG. 9 another resonator such as 970 can be used at much lower power levels earlier in the process flow to characterize the properties of the feedstock and feed that information to the microcontroller 125. Microcontroller can adjust the resonator parameters for the reactor to match the feedstock before it arrives at the reactor.

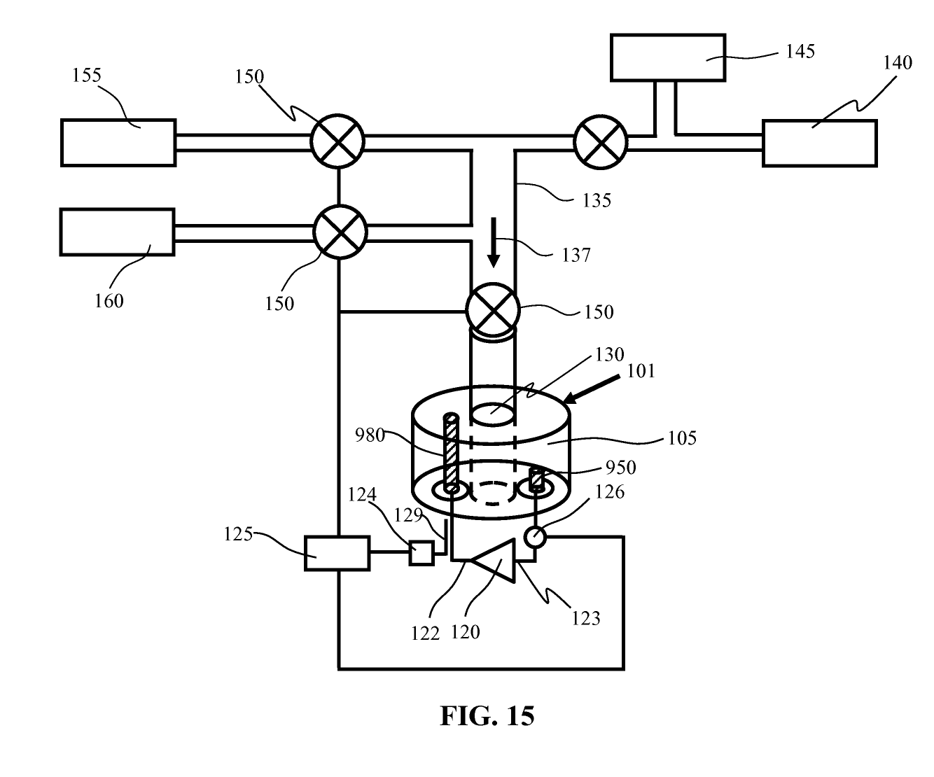

FIG. 15 depicts the cylindrical electromagnetic resonator in FIG. 11A with addition of dynamic feedback to optimize resonator impedance match to the material being heated by adjusting plasma density. FIG. 15 also shows part of the system block diagram shown in FIG. 1. The system includes a feed hopper 145 that contains the feedstock to be reacted, a screw feeder 140 pushes the feedstock through tubing 135 that connects various parts of the system. Similar to FIG. 11A a cylindrical resonator 101 has a hole in the center for a tube that is RF transparent or has low RF loss, to pass through forming reaction zone 130. The feedstock material 137 flows into the reaction zone 130. A number of valves that can be electronically controlled 150 are used at various locations along the tubing to control the flow of gases or materials as well as isolate various parts of the system. Vacuum pump 160 may be used to evacuate the air from tubing and other parts of the system such that the heating of the feedstock can be carried in an Oxygen free or low Oxygen environment. A gas source 155 may be used to provide carrier gases such as Nitrogen or Argon through the tubing to the reaction zone. At high RF fields inside the reactor the Nitrogen or Argon are ionized providing plasma that can be used for high temperature heat treatment of the feedstock.

The inside of a resonator 105 can be filled fully or partially with air or other low-loss dielectric materials. Alternatively the inside of resonator can be filled with multiple low-loss dielectric materials including low-loss liquids. The feedback probe 950 is used to couple a small amount of RF energy from the resonator to feed into a phase shifter 126 and then to the input 123 of the amplifier 120. The output of the amplifier 122 is connected to an RF coupler 129 which then is connected to an input RF probe 980. The coupler 129 is used to measure the reflected RF power from the resonator using an RF detector 124. The output of the RF detector 124 is fed into a microcontroller 125. As the feedstock material passes through the reactor (or as the feedstock material is being heated changing its dielectric properties) the resonant frequency of the cylindrical resonator changes as well as the optimum impedance match for maximum energy transfer to the feedstock changes. This will result in an increase of the reflected power from the resonator that is measured by RF detector 124. A microcontroller 125 can be configured to dynamically adjust the phase shifter 126 and also adjust the electronic valves 150 to control the gas flow and therefore the plasma density inside the reaction zone. By adjusting the phase shifter 126 and the plasma density to minimize the reflected power from the feedstock material 137 passing through the resonator 105, the RF power coupled to the feedstock can be maximized resulting in very efficient continuous heating of feedstock 137. In some cases such as the one shown in FIG. 9 another resonator such as 970 can be used at much lower power levels earlier in the process flow to characterize the properties of the feedstock and feed that information to the microcontroller 125. Microcontroller can adjust the resonator parameters for the reactor to match the feedstock before it arrives at the reactor.

### Description of the Process

In one embodiment of the invention, a plasma mode process may be used. In this embodiment, a plasma may be generated by using a vacuum pump (e.g., FIG. 1, 160) to remove air from the reactor vessel. A gas such as Nitrogen or Argon from a gas source (e.g., FIG. 1, 155) may then be injected into the reaction zone (e.g., FIG. 1, 130) of a resonator (e.g., FIG. 1, 101). RF power may then be delivered to the resonator from an amplifier (FIG. 1, 120) generating high electric fields at the center of the resonator where the reaction zone is located. The high RF fields will ionize the gas inside the reaction zone creating a plasma.

Feedstock may be inserted into the reaction zone from a hopper (FIG. 1, 145). Milling or grinding may be performed on the feedstock prior to insertion into the reaction zone. A drying or preheating process may also be performed on the feedstock by another reactor at lower RF power levels prior to insertion into a main (high power) reactor vessel. Steam or water may optionally be added into the feedstock for enhanced hydrogen production. Catalysts may also be optionally added for improved reactions.

A benefit of embodiments of this invention is that the reaction takes place in a specific localized region of a reactor vessel or feedstock tube, referred to as the reaction zone. This reaction zone may be customized to a specific length and volume along the feedstock tube or reactor vessel based on the resonator design. This localized effect is due to the highly efficient manner in which RF or microwave energy is coupled into the reactor. In one embodiment, an auger system (FIG. 1, 140) may be employed to feed input material through the reactor. The auger system can be precisely calibrated and controlled to transport the feedstock material for specific entry and residence times within the reaction zone.

The reaction may be monitored in real time for input power, temperature, microwave reflectivity and other characteristics. Based on this information the gas pressure, input power and resonator characteristics may be tuned to obtain a desired effect on the feedstock material.

In plasma mode, the pressure of the plasma gas may be controlled to obtain maximum RF energy transfer to the feedstock. In non-plasma mode, air may be vacuumed from the system to achieve a desired level of vacuum for the particular process. In pyrolysis mode oxygen may be removed entirely from the system to prevent oxidation of the feedstock during the heating process.

If an auger system is used to deliver feedstock material to the reaction zone, the rate of the auger may be controlled based on the feedback of the sensor information of the reactor. Depending on the actual reaction time based on sensor information, the auger may either speed up or slow down for optimal processing of the feedstock. This is particularly valuable for non-uniform feedstock, in which some portion of the material may take longer to process than others.

As the feedstock material is processed in the reaction zone and the residence time is complete, the feedstock material is continuously transported out of the reaction zone to be collected and further processed. Solids such as char and ash may be transported to a trap (e.g., FIG. 1, 170). Liquids may be pumped to a container. Gases may be pumped (e.g., FIG. 1, 165) to a condenser for further processing.

The small form factor, high efficiency, scalability, dynamic control and a low capital costs all lend embodiments of the invention to applicability in retrofitting equipment to improve the economics of existing biomass, fossil fuel and industrial processing plants including but not limited to coal, ethanol and biodiesel plants.

### EXAMPLE ONE

### Coal Gasification

Coal can be gasified to produce synthesis gas (syngas), where syngas is primarily composed of carbon monoxide and hydrogen, which can then be combusted in a turbine to generate electricity. Combusting syngas by coal gasification can reduce CO₂, NOₓ and SO₂ pollution in contrast to directly combusting coal. In one embodiment of the present invention coal may be pulverized and ground into small particle sizes, e.g., using a jet mill. The pulverized coal may then be fed into the reaction zone of a system like that shown in FIG. 1 that is used in plasma mode as described above. Steam may be injected into the reaction zone to enhance hydrogen recovery from the coal. This process converts coal into syngas in a highly energy efficient manner, as the energy is uniformly concentrated in a very specific region due to the unique resonator architecture. This approach provides higher uniformity and efficiency than plasma arc approaches. By using a lower amount of electricity instead of fossil fuels it enables a process that could potentially utilize renewable electricity. This is a process that can also be parallelized in an incremental way enabling low-cost retro-fit for existing coal plants. The series architecture described above with respect to FIG. 8 may be applied for preprocessing the coal with hydrogen prior to gasification in non-plasma mode to remove sulfur, which would be performed at different temperatures and pressures than the gasification phase. A post-processing step may also be added to further process solid residue that remains from the gasification phase. This approach can also be used to gasify any carbonaceous fuel source including petcoke, biomass, and municipal hazardous waste to one or more high calorific value gases. It can also be used to process hazardous materials including medical waste.

### EXAMPLE TWO

### Biomass Pyrolysis

Biomass can be processed through thermochemical conversion including pyrolysis and gasification. This process can be pyrolysis or gasification depending on the temperature, reaction time and amount of oxygen. Depending on these characteristics the conversion results in varying compositions of char, liquid (also known as pyrolysis oil) and syngas. Embodiments of the invention enable easy and quick configuration of temperature, reaction time and oxygen amount in order to produce the desired proportions of liquid, char and gas. In one embodiment the invention may be used in non-plasma mode at a pressure range between 5-20 atmospheres and a temperature range between 400 and 800 degrees Celsius to optimize for maximum pyrolysis oil output. Pyrolysis oil is a dense, transportable form of biomass which can be further upgraded to higher value products including fuels and bioplastics. The resulting char can be used for carbon sequestration purposes, for example it can be converted into fertilizer. Resulting syngas can be used for electricity generation. The parallel architecture described above with respect to FIG. 9 may be used to combine a number of reactors whereby each reactor is optimized to produce a different proportion of pyrolysis oil, syngas and char. This results in scalable, automated approach that can dynamically control the proportion of outputs. Furthermore each reactor may be individually dynamically tuned, for example input power and frequency, to compensate for various non-uniformities in the biomass in conjunction with altering the speed of an auger system.

### EXAMPLE THREE

### Petroleum Cracking

Embodiments of the invention may also be used to improve the efficiency and scalability of petroleum refining processes. RF energy has been known to accelerate reaction times while employing lower temperatures and pressures. RF energy provides an effective and efficient method for breaking oil and water emulsions. The resonator architecture enables energy to be concentrated uniformly in a very specific region of the reactor, which enables the use of lower temperature and pressure. This enables lower costs and higher yields to be achieved than traditional microwave and RF based approaches. Embodiments of the invention may be used to replace the heating reactor vessels currently used in a broad range of petroleum refinery processes. Processes that can be improved in terms of efficiency include but are not limited to catalytic cracking, catalytic hydro-cracking and catalytic reforming.

### Water Heating

Embodiments of the invention may be used for energy efficient, instantaneous heating of water. Water heating has residential, commercial and industrial applications, and improving efficiency can have a significant beneficial impact on overall energy consumption. The resonator architecture couples energy with much greater efficiency into the reactor which can heat water with less energy than the prior art in microwave heating. The ability for the resonator architecture to adapt to a range of frequencies and reactor diameters also provides an advantage in developing water heater designs for various applications.

### Food Preparation

The resonator architecture described herein may be applied to an electric oven for food preparation in non-plasma mode. Traditional microwave ovens employ magnetrons for an electromagnetic source which have significant loss and inefficiency when compared to the use of a resonator for focusing energy. Using the resonator architecture described herein instead of a conventional magnetron-based microwave oven, results in an oven that uses less electricity, cooks food faster and with greater uniformity.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “A” or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A device for reacting a feedstock, comprising:
an electromagnetic resonator configured to concentrate electromagnetic energy into a reaction zone within the resonator with sufficient energy density to drive a reaction in a feedstock as the feedstock flows through the reaction zone; and
a feedstock tube disposed in the resonator and the reaction zone, wherein the feedstock tube is configured to permit the flow of the feedstock through the reaction zone.

2. The device of claim 1 wherein the electromagnetic resonator is a cylindrical dielectric resonator that either partially or fully is filled with a dielectric and the reactor vessel/tube is located in the center of the resonator.

3. The device of claim 1 wherein the electromagnetic resonator is a rectangular dielectric resonator that either partially or fully filled with a dielectric and the reaction zone is located proximate a center of the resonator.

4. The device of claim 1 wherein the electromagnetic resonator is a coaxial resonator.

5. The device of claim 1 wherein the electromagnetic resonator includes a distributed structure.

6. The device of claim 1 wherein the electromagnetic resonator includes a lumped circuit.

7. The device of claim 1, further comprising one or more additional resonators wherein each of the one or more additional resonators is configured to concentrate electromagnetic energy into a reaction zone within with sufficient energy density to drive a chemical reaction in the feedstock.

8. The device of claim 7, wherein the resonator and one or more additional resonators are connected in series such that an output of material processed by one resonator provides input material of a successive resonator.

9. The device of claim 7, wherein each of the resonators is optimized for a particular frequency of electromagnetic energy, power input (temperature) and diameter in order to achieve a specific function.

10. The device of claim 7, wherein one of the resonators is used for pre-treatment or post-processing of materials for another resonator.

11. The device of claim 7 wherein the resonators in series are different and each is optimized for efficient RF coupling to a different type of feedstock, or feedstock at different stage of heat treatment, or for heat treating the feedstock at different temperature range.

12. The device of claim 7 wherein the resonator and one or more of the additional resonators are connected in parallel.

13. The device of claim 12, wherein the feedstock tube is split into two or more separate tubes whereby each separate tube passes through the reaction zone of a different one of the resonator and one or more additional resonators.

14. The device of claim 13 wherein the separate tubes are then recombined into a single output tube downstream of the resonator and one or more additional resonators.

15. The device of claim 12 wherein the resonators in parallel are different and each is optimized for efficient RF coupling to a different type of feedstock, or feedstock at different stage of heat treatment, or for heat treating the feedstock at different temperature range.

16. The device of claim 12, further comprising means for characterizing material in the feedstock during processing and directing selected materials in the feedstock through a specific resonator that corresponds to the material characteristics and directing non-selected materials in the feedstock elsewhere.

17. The device of claim 1, further comprising a source of electromagnetic energy coupled to the resonator.

18. The device of claim 1, further comprising an amplifier coupled to the resonator is used in a feedback loop to create an oscillator.

19. The device of claim 1 wherein a feedback loop is configured to implement dynamic impedance matching to the feedstock by measuring reflected power from the resonator and tuning the resonator to minimize reflected power and maximize electromagnetic power coupled to the feedstock.

20. The device of claim 1, further comprising a temperature sensor configured to measure a temperature of the feedstock in the reaction zone and provide feedback to adjust a power of a source of the electromagnetic energy to achieve a desired temperature in the reaction zone.

21. The device of claim 1, further comprising means for adjusting a pressure of the gas inside the reactor to achieve a desired plasma density inside the reaction zone to optimize an impedance match of a source of the electromagnetic energy to the feedstock being heated.

22. The device of claim 10 further comprising means for dynamically adjusting a frequency of the source of electromagnetic energy to match to a changing resonant frequency of the resonator due to changes in dielectric properties of feedstock being heated.

23. The device of claim 1 wherein an electromagnetic field from the resonator is coupled to the feedstock tube by capacitive coupling.

24. The device of claim 1 wherein an electromagnetic field from the resonator is coupled to the feedstock tube by inductive coupling.

25. The device of claim 1 wherein the resonator includes an adjustable sized coupling aperture.

26. The device of claim 1 wherein the resonator includes an electromagnetic waveguide.

27. The device of claim 1, further comprising means for introducing a catalyst into the reaction zone with the feedstock to optimize the reaction as the feedstock flows through the reaction zone.

28. The device of claim 1 wherein resonator is configured to resonate electromagnetic energy having a frequency in a range from sub RF frequencies to high Microwave frequencies.

29. The device of claim 1, further comprising means for tuning a temperature in the reaction zone by changing a frequency of the electromagnetic radiation, a power density of the electromagnetic radiation, and/or a concentration of a carrier gas inside the cavity.

30. A method for reacting a feedstock, comprising:
a) flowing the feedstock through a feedstock tube that passes through a reaction zone of an electromagnetic resonator; and
b) using the electromagnetic resonator to concentrate electromagnetic energy into the reaction zone with sufficient energy density to drive a reaction in the feedstock as the feedstock flows in the feedstock tube through the reaction zone.

31. The method of claim 30 wherein the reaction includes plasma pyrolysis.

32. The method of claim 30 wherein the reaction includes non-plasma pyrolysis.

33. The method of claim 30 wherein the reaction includes plasma gasification.

34. The method of claim 30 wherein the reaction includes non-plasma gasification.

35. The method of claim 30 wherein the reaction includes heating of food or water.

36. The method of claim 30 wherein b) includes creating an intense electromagnetic field and focusing and coupling the electromagnetic field to a carrier gas in the reaction zone to create a plasma in the reaction zone.

37. The method of claim 36 wherein the carrier gas is chosen such that an activation energy for starting the reaction is reduced by atomic species created in the plasma acting as a catalyst to start the reaction.

38. The method of claim 30 wherein the reaction is a chemical reaction converts a carbonaceous feedstock to one or more high calorific value gases.

39. The method of claim 30 wherein the reaction is a chemical reaction takes place via anaerobic heating in a plasma.

40. The method of claim 30, wherein the resonator and one or more additional resonators are connected in series such that an output of material processed by one resonator provides input material of a successive resonator.

41. The method of claim 30 wherein the resonator and one or more of the additional resonators are connected in parallel.

42. The method of claim 41 wherein the resonators in parallel are different and each is optimized for efficient RF coupling to a different type of feedstock, or feedstock at different stage of heat treatment, or for heat treating the feedstock at different temperature range.

43. The method of claim 42, further comprising means for characterizing material in the feedstock during processing and directing selected materials in the feedstock through a specific resonator that corresponds to the material characteristics and directing non-selected materials in the feedstock elsewhere.

44. The method of claim 30 wherein b) includes using a feedback to implement dynamic impedance matching to the feedstock by measuring reflected power from the resonator and tuning the resonator to minimize reflected power and maximize electromagnetic power coupled to the feedstock.

45. The method of claim 30, further comprising measuring a temperature of the feedstock in the reaction zone and using the measured temperature to provide feedback to adjust a power of a source of the electromagnetic energy to achieve a desired temperature in the reaction zone.

46. The method of claim 30, further comprising adjusting a pressure of the gas inside the reactor to achieve a desired plasma density inside the reaction zone to optimize an impedance match of a source of the electromagnetic energy to the feedstock being heated.

47. The method of claim 46 further comprising dynamically adjusting a frequency of the source of electromagnetic energy to match to a changing resonant frequency of the resonator due to changes in dielectric properties of feedstock being heated.

48. The method of claim 30 wherein b) includes coupling an electromagnetic field from the resonator to the feedstock tube by capacitive coupling.

49. The method of claim 30 wherein b) includes coupling an electromagnetic field from the resonator to the feedstock tube using by inductive coupling.

50. The method of claim 30, further comprising adjusting an electromagnetic power coupled to the feedstock by changing a size of a coupling aperture of the resonator.

51. The method of claim 30, further comprising introducing a catalyst into the reaction zone with the feedstock to optimize the reaction as the feedstock flows through the reaction zone.
